(19) United States
(12) Patent Application Publication
(10) Pub. No.: US 2024/0190112 A1
(43) Pub. Date: Jun. 13, 2024

(54) RESIN COMPOSITION, PREPREG, RESIN-COATED FILM, RESIN-COATED METAL FOIL, METAL-CLAD LAMINATE, AND WIRING BOARD

(71) Applicant: PANASONIC INTELLECTUAL PROPERTY MANAGEMENT CO., LTD., Osaka (JP)

(72) Inventors: Kosuke TSUDA, Osaka (JP); Hirosuke SAITO, Osaka (JP); Yasunori NISHIGUCHI, Osaka (JP); Hiroharu INOUE, Osaka (JP)

(73) Assignee: PANASONIC INTELLECTUAL PROPERTY MANAGEMENT CO., LTD., Osaka (JP)

(21) Appl. No.: 18/283,258

(22) PCT Filed: Mar. 9, 2022
(86) PCT No.: PCT/JP2022/010427

§ 371 Date: Sep. 21, 2023

(30) Foreign Application Priority Data
Mar. 24, 2021 (JP) 2021-050474

(51) Int. Cl. B32B 27/18; B32B 15/08; B32B 15/20; B32B 27/28; C08J 5/24; C08K 3/11

(52) U.S. Cl. CPC B32B 27/18; B32B 15/08; B32B 15/20; B32B 27/285; C08J 5/244; C08K 3/11; B32B 2264/1022; B32B 2307/204; B32B 2307/304; B32B 2371/00; B32B 2457/08; C08J 2371/12

(57) ABSTRACT

An aspect of the present invention is a resin composition containing at least one of a polyphenylene ether compound (A), having at least one of a group represented by the following Formula (1) and a group represented by the following Formula (2) in the molecule, and a maleimide compound (B); and ceramic particles (C) including aluminum titanate particles (C1).

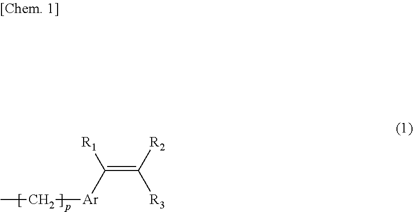

In Formula (1), p represents 0 to 10, Ar represents an arylene group, and R₁ to R₃ each independently represent a hydrogen atom or an alkyl group.

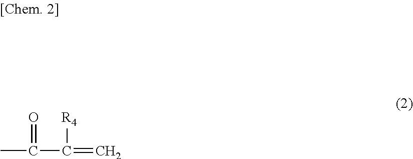

In Formula (2), R₄ represents a hydrogen atom or an alkyl group.

### TECHNICAL FIELD

The present invention relates to a resin composition, a prepreg, a film with resin, a metal foil with resin, a metal-clad laminate, and a wiring board.

### BACKGROUND ART

Wiring boards used in electronic devices are required to be compatible with high frequencies when used as, for example, wiring boards for antennas. Substrate materials for forming insulating layers included in such wiring boards compatible with high frequencies are required to have a low dielectric loss tangent in order to decrease the signal transmission loss. The substrate materials are also required to have a high relative dielectric constant in order to miniaturize the wiring boards. Examples of such substrate materials include resin compositions containing fillers having a high relative dielectric constant.

Examples of such resin compositions containing fillers having a high relative dielectric constant include the resin composition described in Patent Literature 1. Patent Literature 1 describes a resin composition in which a predetermined amount of a high dielectric constant inorganic insulating filler having a predetermined particle size is blended with a mixed resin obtained by mixing a thermosetting polyphenylene ether having a predetermined molecular weight and terminals modified with styrene and a styrene-based elastomer at a predetermined ratio. Patent Literature 1 discloses that a prepreg obtained by attaching the resin composition to a glass cloth or glass nonwoven fabric has a high dielectric constant and a low dielectric loss tangent. Patent Literature 1 also discloses that this prepreg can be molded without voids or cracks at the time of laminate molding, is excellent in workability, safety, and environmental friendliness at the time of manufacturing, and so can be suitably used as a substrate material for electronic devices.

By containing a filler having a high relative dielectric constant, for example, strontium titanate used as the high dielectric constant inorganic insulating filler in Patent Literature 1, it is considered that a resin composition, which affords a cured product having a high relative dielectric constant, is obtained. However, by containing a filler having a high relative dielectric constant, the dielectric loss tangent may also increase even though the relative dielectric constant can be increased.

### CITATION LIST

### Patent Literature

Patent Literature 1: WO 2010/147083 A

### SUMMARY OF INVENTION

The present invention has been made in view of such circumstances, and an object thereof is to provide a resin composition, which affords a cured product having a high relative dielectric constant and a low dielectric loss tangent. Another object of the present invention is to provide a prepreg, a film with resin, a metal foil with resin, a metal-clad laminate, and a wiring board, which are obtained using the resin composition.

An aspect of the present invention is a resin composition containing at least one of a polyphenylene ether compound (A), having at least one of a group represented by the following Formula (1) and a group represented by the following Formula (2) in the molecule, and a maleimide compound (B); and ceramic particles (C) including aluminum titanate particles (C1).

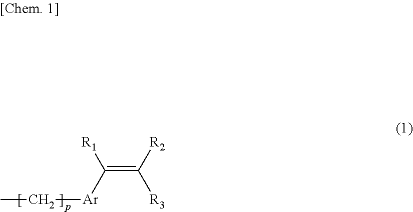

In Formula (1), p represents 0 to 10, Ar represents an arylene group, and R₁ to R₃ each independently represent a hydrogen atom or an alkyl group.

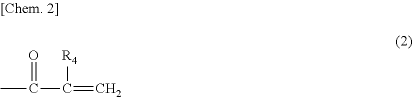

In Formula (2), R₄ represents a hydrogen atom or an alkyl group.

### BRIEF DESCRIPTION OF DRAWINGS

FIG. 1 is a schematic sectional view illustrating an example of a prepreg according to an embodiment of the present invention.

FIG. 2 is a schematic sectional view illustrating an example of a metal-clad laminate according to an embodiment of the present invention.

FIG. 3 is a schematic sectional view illustrating an example of a wiring board according to an embodiment of the present invention.

FIG. 4 is a schematic sectional view illustrating an example of a metal foil with resin according to an embodiment of the present invention.

FIG. 5 is a schematic sectional view illustrating an example of a film with resin according to an embodiment of the present invention.

### DESCRIPTION OF EMBODIMENTS

In order to increase the relative dielectric constant of a cured product of a resin composition, it is conceivable to contain a filler having a high relative dielectric constant as described above. In order to further increase the relative dielectric constant of a cured product of a resin composition, it is also conceivable to increase the content of a filler having a high relative dielectric constant in the resin composition. However, according to the studies of the present inventors, by simply containing a filler having a high relative dielectric constant, as described above, the dielectric loss tangent may also increase even though the relative dielectric constant can be increased depending on the composition of the resin component and filler contained in the resin composition, and the like. In such a case, by simply increasing the content of a filler having a high relative dielectric constant in the resin composition, it is considered that the dielectric loss tangent also further increases even though the relative dielectric constant can be further increased. Moreover, when the content of a filler having a high relative dielectric constant is excessively increased, performance other than the dielectric properties such as relative dielectric constant and dielectric loss tangent may decrease. As a result of extensive studies, the present inventors have found out that not only the resin component contained in a resin composition but also the kind, composition, and the like of the filler affect dielectric properties such as relative dielectric constant and dielectric loss tangent of a cured product. The present inventors have conducted extensive studies, including studies on this effect, and as a result, found out that the objects are achieved by the present invention described below.

Hereinafter, embodiments according to the present invention will be described, but the present invention is not limited thereto.

### Resin Composition

A resin composition according to an embodiment of the present invention is a resin composition containing at least one of a polyphenylene ether compound (A), having at least one of a group represented by the following Formula (1) and a group represented by the following Formula (2) in the molecule, and a maleimide compound (B); and ceramic particles (C) including aluminum titanate particles (C1). The resin composition may contain one of the polyphenylene ether compound (A) and the maleimide compound (B), or may contain both of these. By curing the resin composition having such a configuration, a cured product having a high relative dielectric constant and a low dielectric loss tangent is obtained.

By curing one of the polyphenylene ether compound (A) and the maleimide compound (B) contained in the resin composition, it is considered that a cured product having a low dielectric loss tangent is obtained. This cured product is considered to have a low relative dielectric constant as well as a low dielectric loss tangent, but it is considered that the relative dielectric constant of the cured product can be increased by containing the ceramic particles (C) in the resin composition. Since the ceramic particles (C) include the aluminum titanate particles (C1), it is considered that the relative dielectric constant can be increased while an increase in the dielectric loss tangent of the cured product is suppressed by containing the ceramic particles (C) in the resin composition. From these facts, it is considered that a cured product having a high relative dielectric constant and a low dielectric loss tangent is obtained by curing the resin composition.

As thinning of wiring boards proceeds, there is a tendency that warping of semiconductor packages in which semiconductor chips are mounted on wiring boards occurs and mounting failures are likely to occur. In order to suppress warping of semiconductor packages in which semiconductor chips are mounted on wiring boards, the insulating layers are required to have a low coefficient of thermal expansion. Hence, substrate materials for forming insulating layers of wiring boards are required to afford cured products having a low coefficient of thermal expansion. For this reason, substrate materials of wiring boards and the like are required to have a high relative dielectric constant and a low dielectric loss tangent, as described above, and are further required to have a low coefficient of thermal expansion so as to be compatible with high frequencies. In the wiring boards, miniaturized wiring is also required not to peel off from the insulating layers, and thus it is further required that adhesive properties between the wiring and the insulating layers are high. Hence, it is required that adhesive properties between the metal foils and the insulating layers are high in metal-clad laminates and metal foils with resin, and substrate materials for forming insulating layers of wiring boards are required to afford cured products exhibiting excellent adhesive properties to metal foils. In regard to these, the resin composition according to the present embodiment affords a cured product having not only a high relative dielectric constant and a low dielectric loss tangent but also a low coefficient of thermal expansion and excellent adhesive properties to a metal foil.

### Polyphenylene Ether (A)

The polyphenylene ether (A) is not particularly limited as long as it is a polyphenylene ether compound having at least one (substituent) of a group represented by the following Formula (1) and a group represented by the following Formula (2) in the molecule. Examples of the polyphenylene ether compound include polyphenylene ether compounds having at least one of a group represented by the following Formula (1) and a group represented by the following Formula (2) at the molecular terminals, such as a modified polyphenylene ether compound of which the terminals are modified with at least one of a group represented by the following Formula (1) and a group represented by the following Formula (2).

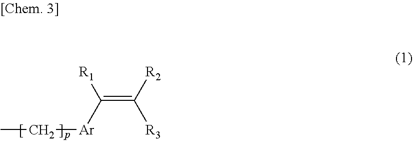

In Formula (1), R₁ to R₃ are independent of each other. In other words, R₁ to R₃ may be the same group as or different groups from each other. R₁ to R₃ represent a hydrogen atom or an alkyl group. Ar represents an arylene group. p represents 0 to 10. In a case where p in Formula (1) is 0, it indicates that Ar is directly bonded to the terminal of polyphenylene ether.

The arylene group is not particularly limited. Examples of this arylene group include a monocyclic aromatic group such as a phenylene group and a polycyclic aromatic group that is polycyclic aromatic such as a naphthalene ring. This arylene group also includes a derivative in which a hydrogen atom bonded to an aromatic ring is substituted with a functional group such as an alkenyl group, an alkynyl group, a formyl group, an alkylcarbonyl group, an alkenylcarbonyl group, or an alkynylcarbonyl group.

The alkyl group is not particularly limited and is, for example, preferably an alkyl group having 1 to 18 carbon atoms and more preferably an alkyl group having 1 to 10 carbon atoms. Specific examples thereof include a methyl group, an ethyl group, a propyl group, a hexyl group, and a decyl group.

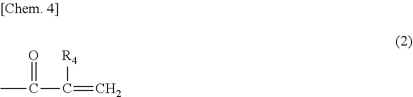

In Formula (2), R₄ represents a hydrogen atom or an alkyl group.

The alkyl group is not particularly limited and is, for example, preferably an alkyl group having 1 to 18 carbon atoms and more preferably an alkyl group having 1 to 10 carbon atoms. Specific examples thereof include a methyl group, an ethyl group, a propyl group, a hexyl group, and a decyl group.

Examples of the group represented by Formula (1) include a vinylbenzyl group (ethenylbenzyl group) represented by the following Formula (3). Examples of the group represented by Formula (2) include an acryloyl group and a methacryloyl group.

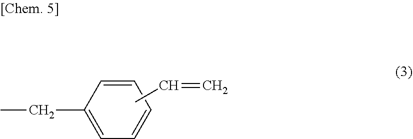

More specific examples of the substituent (at least one of the group represented by Formula (1) and the group represented by Formula (2)) include vinylbenzyl groups (ethenylbenzyl groups) such as an o-ethenylbenzyl group, a m-ethenylbenzyl group, and a p-ethenylbenzyl group, a vinylphenyl group, an acryloyl group, and a methacryloyl group. The polyphenylene ether compound may have one kind of substituent or two or more kinds of substituents as the substituent. The polyphenylene ether compound may have, for example, any of an o-ethenylbenzyl group, a m-ethenylbenzyl group, or a p-ethenylbenzyl group, or two or three kinds thereof.

The polyphenylene ether compound has a polyphenylene ether chain in the molecule and preferably has, for example, a repeating unit represented by the following Formula (4) in the molecule.

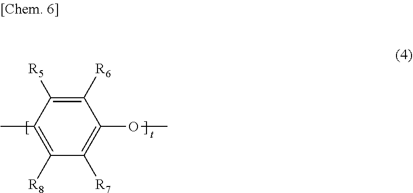

In Formula (4), t represents 1 to 50. R₅ to R₈ are independent of each other. In other words, R₅ to R₈ may be the same group as or different groups from each other. R₅ to R₈ represent a hydrogen atom, an alkyl group, an alkenyl group, an alkynyl group, a formyl group, an alkylcarbonyl group, an alkenylcarbonyl group, or an alkynylcarbonyl group. Among these, a hydrogen atom and an alkyl group are preferable.

Specific examples of the respective functional groups mentioned in R₅ to R₈ include the following.

The alkyl group is not particularly limited and is, for example, preferably an alkyl group having 1 to 18 carbon atoms, more preferably an alkyl group having 1 to 10 carbon atoms. Specific examples thereof include a methyl group, an ethyl group, a propyl group, a hexyl group, and a decyl group.

The alkenyl group is not particularly limited and is, for example, preferably an alkenyl group having 2 to 18 carbon atoms, more preferably an alkenyl group having 2 to 10 carbon atoms. Specific examples thereof include a vinyl group, an allyl group, and a 3-butenyl group.

The alkynyl group is not particularly limited and is, for example, preferably an alkynyl group having 2 to 18 carbon atoms, more preferably an alkynyl group having 2 to 10 carbon atoms. Specific examples thereof include an ethynyl group and a prop-2-yn-1-yl group (propargyl group).

The alkylcarbonyl group is not particularly limited as long as it is a carbonyl group substituted with an alkyl group and is, for example, preferably an alkylcarbonyl group having 2 to 18 carbon atoms, more preferably an alkylcarbonyl group having 2 to 10 carbon atoms. Specific examples thereof include an acetyl group, a propionyl group, a butyryl group, an isobutyryl group, a pivaloyl group, a hexanoyl group, an octanoyl group, and a cyclohexylcarbonyl group.

The alkenylcarbonyl group is not particularly limited as long as it is a carbonyl group substituted with an alkenyl group and is, for example, preferably an alkenylcarbonyl group having 3 to 18 carbon atoms, more preferably an alkenylcarbonyl group having 3 to 10 carbon atoms. Specific examples thereof include an acryloyl group, a methacryloyl group, and a crotonoyl group.

The alkynylcarbonyl group is not particularly limited as long as it is a carbonyl group substituted with an alkynyl group and is, for example, preferably an alkynylcarbonyl group having 3 to 18 carbon atoms, more preferably an alkynylcarbonyl group having 3 to 10 carbon atoms. Specific examples thereof include a propioloyl group.

The weight average molecular weight (Mw) and number average molecular weight (Mn) of the polyphenylene ether compound are not particularly limited, and specifically, are preferably 500 to 5,000, more preferably 800 to 4,000, still more preferably 1,000 to 3,000. Here. the weight average molecular weight and number average molecular weight may be those measured by general molecular weight measurement methods, and specific examples thereof include values measured by gel permeation chromatography (GPC). In a case where the polyphenylene ether compound has a repeating unit represented by Formula (4) in the molecule, t is preferably a numerical value so that the weight average molecular weight and number average molecular weight of the polyphenylene ether compound is in such a range. Specifically, t is preferably 1 to 50.

When the weight average molecular weight and number average molecular weight of the polyphenylene ether compound are in the above range, the excellent low dielectric properties of polyphenylene ether are exhibited, and not only the heat resistance of the cured product is superior but also the moldability is excellent. This is considered to be due to the following. When the weight average molecular weight and number average molecular weight of ordinary polyphenylene ether are in the above range, the molecular weight is relatively low, and thus the heat resistance tends to decrease. With regard to this point, it is considered that since the polyphenylene ether compound according to the present embodiment has one or more unsaturated double bonds at the terminal, a cured product exhibiting sufficiently high heat resistance is obtained as the curing reaction proceeds. When the weight average molecular weight and number average molecular weight of the polyphenylene ether compound are in the above range, it is considered that the molecular weight is relatively low and thus the moldability is also excellent. Hence, it is considered that such a polyphenylene ether compound not only imparts superior heat resistance to the cured product but also exhibits excellent moldability.

In the polyphenylene ether compound, the average number of the substituents (number of terminal functional groups) at the molecule terminal per one molecule of the polyphenylene ether compound is not particularly limited. Specifically, the average number is preferably 1 to 5, more preferably 1 to 3, and still more preferably 1.5 to 3. When the number of terminal functional groups is too small, sufficient heat resistance of the cured product tends to be hardly attained. When the number of terminal functional groups is too large, the reactivity is too high and, for example, troubles such as deterioration in the storage stability of the resin composition or deterioration in the fluidity of the resin composition may occur. In other words, when such a polyphenylene ether compound is used, for example, molding defects such as generation of voids at the time of multilayer molding occur by insufficient fluidity and the like and a problem of moldability that a highly reliable printed wiring board is hardly obtained may occur.

The number of terminal functional groups in the polyphenylene ether compound includes a numerical value expressing the average value of the substituents per one molecule of all the polyphenylene ether compounds present in 1 mole of the polyphenylene ether compound. This number of terminal functional groups can be determined by, for example, measuring the number of hydroxyl groups remaining in the obtained polyphenylene ether compound and calculating the number of hydroxyl groups decreased from the number of hydroxyl groups in the polyphenylene ether before having (before being modified with) the substituent. The number of hydroxyl groups decreased from the number of hydroxyl groups in the polyphenylene ether before being modified is the number of terminal functional groups. Moreover, with regard to the method for measuring the number of hydroxyl groups remaining in the polyphenylene ether compound, the number of hydroxyl groups can be determined by adding a quaternary ammonium salt (tetraethylammonium hydroxide) to be associated with a hydroxyl group to a solution of the polyphenylene ether compound and measuring the UV absorbance of the mixed solution.

The intrinsic viscosity of the polyphenylene ether compound is not particularly limited. Specifically, the intrinsic viscosity is preferably 0.03 to 0.12 dl/g, more preferably 0.04 to 0.11 dl/g, still more preferably 0.06 to 0.095 dl/g. When the intrinsic viscosity is too low, the molecular weight tends to be low and low dielectric properties such as a low dielectric loss tangent tend to be hardly attained. When the intrinsic viscosity is too high, the viscosity is high, sufficient fluidity is not attained, and the moldability of the cured product tends to decrease. Hence, when the intrinsic viscosity of the polyphenylene ether compound is in the above range, excellent heat resistance and moldability of the cured product can be realized.

Note that the intrinsic viscosity here is an intrinsic viscosity measured in methylene chloride at 25° C. and more specifically is, for example, a value attained by measuring the intrinsic viscosity of a methylene chloride solution (liquid temperature: 25° C.) at 0.18 g/45 ml using a viscometer. Examples of the viscometer include AVS500 Visco System manufactured by SCHOTT Instruments GmbH.

Examples of the polyphenylene ether compound include a polyphenylene ether compound represented by the following Formula (5) and a polyphenylene ether compound represented by the following Formula (6). As the polyphenylene ether compound, these polyphenylene ether compounds may be used singly or these two kinds of polyphenylene ether compounds may be used in combination.

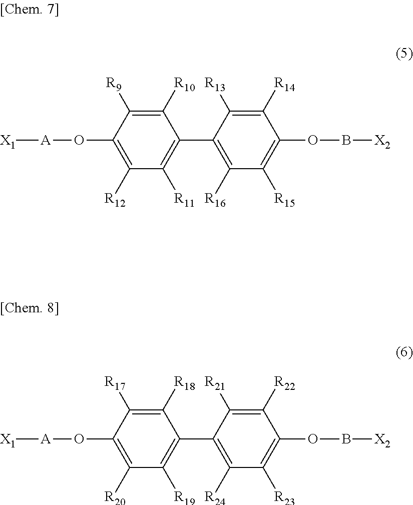

In Formulas (5) and (6), R₉ to R₁₆ and R₁₇ to R₂₄ are independent of each other. In other words, R₉ to R₁₆ and R₁₇ to R₂₄ may be the same group as or different groups from each other. R₉ to R₁₆ and R₁₇ to R₂₄ represent a hydrogen atom, an alkyl group, an alkenyl group, an alkynyl group, a formyl group, an alkylcarbonyl group, an alkenylcarbonyl group, or an alkynylcarbonyl group. X₁ and X₂ are independent of each other. In other words, X₁ and X₂ may be the same group as or different groups from each other. X₁ and X₂ represent a substituent having a carbon-carbon unsaturated double bond. A and B represent a repeating unit represented by the following Formula (7) and a repeating unit represented by the following Formula (8), respectively. In Formula (6), Y represents a linear, branched, or cyclic hydrocarbon having 20 or less carbon atoms.

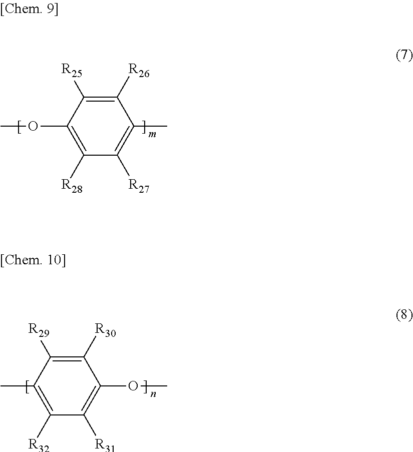

In Formulas (7) and (8), m and n each represent 0 to 20. R₂₅ to R₂₈ and R₂₉ to R₃₂ are independent of each other. In other words, R₂₅ to R₂₈ and R₂₉ to R₃₂ may be the same group as or different groups from each other. R₂₅ to R₂₈ and R₂₉ to R₃₂ represent a hydrogen atom, an alkyl group, an alkenyl group, an alkynyl group, a formyl group, an alkylcarbonyl group, an alkenylcarbonyl group, or an alkynylcarbonyl group.

The polyphenylene ether compound represented by Formula (5) and the polyphenylene ether compound represented by Formula (6) are not particularly limited as long as they are compounds satisfying the configuration. Specifically, in Formulas (5) and (6), R₉ to R₁₆ and R₁₇ to R₂₄ are independent of each other as described above. In other words, R₉ to R₁₆ and R₁₇ to R₂₄ may be the same group as or different groups from each other. R₉ to R₁₆ and R₁₇ to R₂₄ represent a hydrogen atom, an alkyl group, an alkenyl group, an alkynyl group, a formyl group, an alkylcarbonyl group, an alkenylcarbonyl group, or an alkynylcarbonyl group. Among these, a hydrogen atom and an alkyl group are preferable.

In Formulas (7) and (8), m and n each preferably represent 0 to 20 as described above. In addition, it is preferable that m and n represent numerical values so that the sum of m and n is 1 to 30. Hence, it is more preferable that m represents 0 to 20, n represents 0 to 20, and the sum of m and n represents 1 to 30. R₂₅ to R₂₈ and R₂₉ to R₃₂ are independent of each other. In other words, R₂₅ to R₂₈ and R₂₉ to R₃₂ may be the same group as or different groups from each other. R₂₅ to R₂₈ and R₂₉ to R₃₂ represent a hydrogen atom, an alkyl group, an alkenyl group, an alkynyl group, a formyl group, an alkylcarbonyl group, an alkenylcarbonyl group, or an alkynylcarbonyl group. Among these, a hydrogen atom and an alkyl group are preferable.

R₉ to R₃₂ are the same as R₅ to R₈ in Formula (4).

In Formula (6), Y represents a linear, branched, or cyclic hydrocarbon having 20 or less carbon atoms as described above. Examples of Y include a group represented by the following Formula (9).

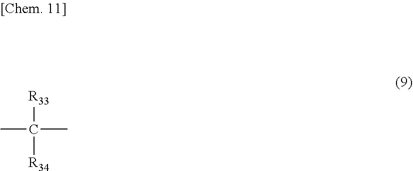

In Formula (9), R₃₃ and R₃₄ each independently represent a hydrogen atom or an alkyl group. Examples of the alkyl group include a methyl group. Examples of the group represented by Formula (9) include a methylene group, a methylmethylene group, and a dimethylmethylene group. Among these, a dimethylmethylene group is preferable.

In Formulas (5) and (6), X₁ and X₂ each independently represent a substituent having a carbon-carbon double bond. In the polyphenylene ether compound represented by Formula (5) and the polyphenylene ether compound represented by Formula (6), X₁ and X₂ may be the same group as or different groups from each other.

More specific examples of the polyphenylene ether compound represented by Formula (5) include a polyphenylene ether compound represented by the following Formula (10).

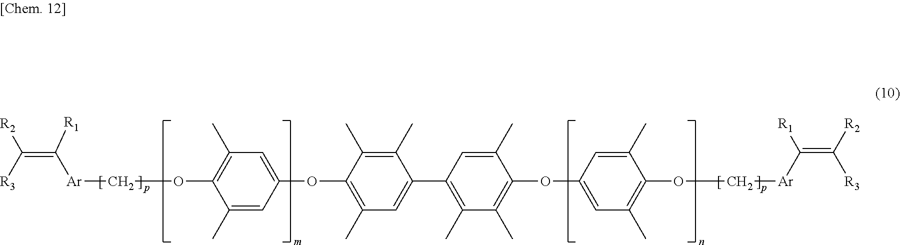

More specific examples of the polyphenylene ether compound represented by Formula (6) include a polyphenylene ether compound represented by the following Formula (11) and a polyphenylene ether compound represented by the following Formula (12).

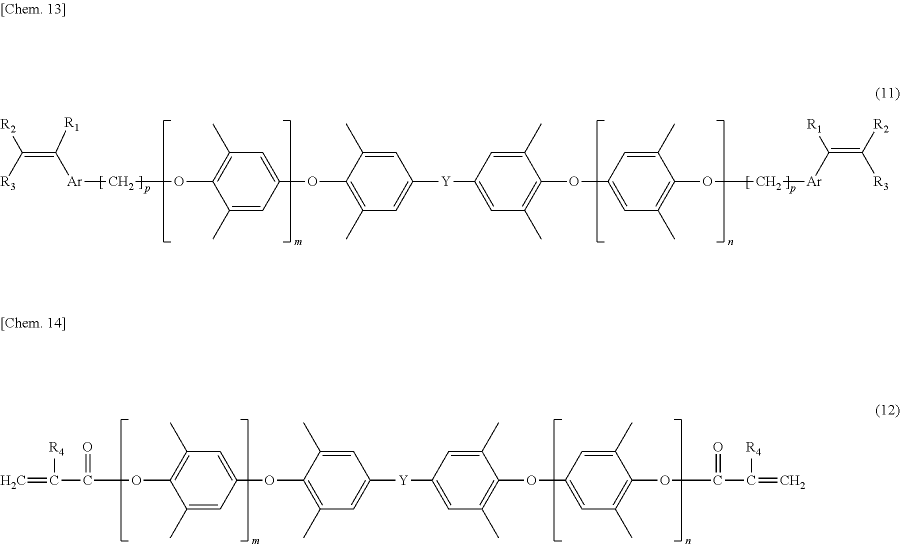

In Formulas (10) to (12), m and n are the same as m and n in Formulas (7) and (8). In Formulas (10) and (11), R₁ to R₃, p, and Ar are the same as R₁ to R₃, p, and Ar in Formula (1). In Formulas (11) and (12), Y is the same as Y in Formula (6). In Formula (12), R₄ is the same as R₄ in Formula (2).

The method for synthesizing the polyphenylene ether compound used in the present embodiment is not particularly limited as long as a polyphenylene ether compound having the substituent in the molecule can be synthesized. Specific examples of the method include a method in which polyphenylene ether is reacted with a compound in which the substituent is bonded to a halogen atom.

Examples of the compound in which the substituent is bonded to a halogen atom include compounds in which substituents represented by Formulas (1) to (3) are bonded to halogen atoms. Specific examples of the halogen atom include a chlorine atom, a bromine atom, an iodine atom, and a fluorine atom. Among these, a chlorine atom is preferable. More specific examples of the compound in which a substituent having a carbon-carbon unsaturated double bond is bonded to a halogen atom include o-chloromethylstyrene, p-chloromethylstyrene, and m-chloromethylstyrene. The compound in which a substituent having a carbon-carbon unsaturated double bond is bonded to a halogen atom may be used singly or in combination of two or more kinds thereof. For example, o-chloromethylstyrene, p-chloromethylstyrene, and m-chloromethylstyrene may be used singly or in combination of two or three kinds thereof.

Polyphenylene ether that is a raw material is not particularly limited as long as a predetermined polyphenylene ether compound can be finally synthesized. Specific examples thereof include those containing polyphenylene ether containing 2,6-dimethylphenol and at least one of a bifunctional phenol and a trifunctional phenol and polyphenylene ether such as poly(2,6-dimethyl-1,4-phenylene oxide) as a main component. The bifunctional phenol is a phenol compound having two phenolic hydroxyl groups in the molecule, and examples thereof include tetramethyl bisphenol A. The trifunctional phenol is a phenol compound having three phenolic hydroxyl groups in the molecule.

Examples of the method for synthesizing the polyphenylene ether compound include the methods described above. Specifically, polyphenylene ether as described above and the compound in which a substituent having a carbon-carbon unsaturated double bond is bonded to a halogen atom are dissolved in a solvent and stirred. By doing so, polyphenylene ether reacts with the compound in which a substituent having a carbon-carbon unsaturated double bond is bonded to a halogen atom, and the polyphenylene ether compound used in the present embodiment is obtained.

The reaction is preferably conducted in the presence of an alkali metal hydroxide. By doing so, it is considered that this reaction suitably proceeds. This is considered to be because the alkali metal hydroxide functions as a dehydrohalogenating agent, specifically, a dehydrochlorinating agent. In other words, it is considered that the alkali metal hydroxide eliminates the hydrogen halide from the phenol group in polyphenylene ether and the compound in which a substituent having a carbon-carbon unsaturated double bond is bonded to a halogen atom, and by doing so, the substituent having a carbon-carbon unsaturated double bond is bonded to the oxygen atom of the phenol group instead of the hydrogen atom of the phenol group in polyphenylene ether.

The alkali metal hydroxide is not particularly limited as long as it can act as a dehalogenating agent, and examples thereof include sodium hydroxide. The alkali metal hydroxide is usually used in the form of an aqueous solution and is specifically used as an aqueous sodium hydroxide solution.

The reaction conditions such as reaction time and reaction temperature also vary depending on the compound in which a substituent having a carbon-carbon unsaturated double bond is bonded to a halogen atom, and the like, and are not particularly limited as long as they are conditions under which the reaction as described above suitably proceeds. Specifically, the reaction temperature is preferably room temperature to 100° C. and more preferably 30° C. to 100° C. In addition, the reaction time is preferably 0.5 to 20 hours and more preferably 0.5 to 10 hours.

The solvent used at the time of the reaction is not particularly limited as long as it can dissolve polyphenylene ether and the compound in which a substituent having a carbon-carbon unsaturated double bond is bonded to a halogen atom, and does not inhibit the reaction of polyphenylene ether with the compound in which a substituent having a carbon-carbon unsaturated double bond is bonded to a halogen atom. Specific examples thereof include toluene.

The above reaction is preferably conducted in the presence of not only an alkali metal hydroxide but also a phase transfer catalyst. In other words, the above reaction is preferably conducted in the presence of an alkali metal hydroxide and a phase transfer catalyst. By doing so, it is considered that the above reaction more suitably proceeds. This is considered to be due to the following. This is considered to be because the phase transfer catalyst is a catalyst which has a function of taking in the alkali metal hydroxide, is soluble in both phases of a phase of a polar solvent such as water and a phase of a non-polar solvent such as an organic solvent, and can transfer between these phases. Specifically, in a case where an aqueous sodium hydroxide solution is used as an alkali metal hydroxide and an organic solvent, such as toluene, which is incompatible with water is used as a solvent, it is considered that when the aqueous sodium hydroxide solution is dropped into the solvent subjected to the reaction as well, the solvent and the aqueous sodium hydroxide solution are separated from each other and the sodium hydroxide is hardly transferred to the solvent. In that case, it is considered that the aqueous sodium hydroxide solution added as an alkali metal hydroxide hardly contributes to the promotion of the reaction. In contrast, when the reaction is conducted in the presence of an alkali metal hydroxide and a phase transfer catalyst, it is considered that the alkali metal hydroxide is transferred to the solvent in the state of being taken in the phase transfer catalyst and the aqueous sodium hydroxide solution is likely to contribute to the promotion of the reaction. For this reason, when the reaction is conducted in the presence of an alkali metal hydroxide and a phase transfer catalyst, it is considered that the above reaction more suitably proceeds.

The phase transfer catalyst is not particularly limited, and examples thereof include quaternary ammonium salts such as tetra-n-butylammonium bromide.

The resin composition used in the present embodiment preferably contains a polyphenylene ether compound obtained as described above as the polyphenylene ether compound.

### Maleimide Compound (B)

The maleimide compound (B) is not particularly limited as long as it is a compound having a maleimide group in the molecule. Examples of the maleimide compound (B) include a monofunctional maleimide compound having one maleimide group in the molecule, a polyfunctional maleimide compound having two or more maleimide groups in the molecule, and a modified maleimide compound. Examples of the modified maleimide compound include a modified maleimide compound in which a part of the molecule is modified with an amine compound, a modified maleimide compound in which a part of the molecule is modified with a silicone compound, and a modified maleimide compound in which a part of the molecule is modified with an amine compound and a silicone compound. The functional group equivalent of the maleimide group in the maleimide compound (B) is preferably 100 to 2000 g/eq., more preferably 150 to 500 g/eq. The molecular weight of the maleimide compound (B) is preferably 300 to 4000, more preferably 450 to 1000. The molecular weight is the number average molecular weight in a case where the maleimide compound is a polymer such as an oligomer.

As the maleimide compound (B), it is preferable to contain, for example, at least one of a maleimide compound (B1) having a phenylmaleimide group in the molecule and a maleimide compound (B2) having an aliphatic hydrocarbon group having 11 or more carbon atoms in the molecule. As the maleimide compound (B), one of these may be used, or these two may be used in combination. The maleimide compound (B) may be a maleimide compound other than the maleimide compound (B1) having a phenylmaleimide group in the molecule and the maleimide compound (B2) having an aliphatic hydrocarbon group having 11 or more carbon atoms in the molecule.

### Maleimide Compound (B1) having Phenylmaleimide Group in Molecule

The maleimide compound (B1) having a phenylmaleimide group in the molecule is not particularly limited as long as it is a maleimide compound having a phenylmaleimide group in the molecule, and examples thereof include a maleimide compound having a phenylmaleimide group and an aliphatic hydrocarbon group having 10 or less carbon atoms in the molecule.

Examples of the maleimide compound (B1) having a phenylmaleimide group in the molecule include 4,4′-diphenylmethanebismaleimide, polyphenylmethanebismaleimide, m-phenylenebismaleimide, bisphenol A diphenyl ether bismaleimide, 3,3′-dimethyl-5,5′-diethyl-4,4′-diphenylmethanebismaleimide, 4-methyl-1,3-phenylenebismaleimide, 1,6′-bismaleimide-(2,2,4-trimethyl)hexane, biphenylaralkyl-type maleimide resin, and a maleimide compound having a phenylmaleimide group and an arylene structure substituted at the meta position in the molecule.

A commercial product can be used as such a maleimide compound. Specifically, as 4,4′-diphenylmethanebismaleimide, for example, BMI-1000 manufactured by Daiwa Kasei Industry Co., Ltd.) can be used. As polyphenylmethane maleimide, for example, BMI-2300 manufactured by Daiwa Kasei Industry Co., Ltd. can be used. As m-phenylene bismaleimide, for example, BMI-3000 manufactured by Daiwa Kasei Industry Co., Ltd. can be used. As bisphenol A diphenyl ether bismaleimide, for example, BMI-4000 manufactured by Daiwa Kasei Industry Co., Ltd. can be used. As 3,3′-dimethyl-5,5′-diethyl-4,4′-diphenylmethanebismaleimide, for example, BMI-5100 manufactured by Daiwa Kasei Industry Co., Ltd. can be used. As 4-methyl-1,3-phenylenebismaleimide, for example, BMI-7000 manufactured by Daiwa Kasei Industry Co., Ltd. can be used. As 1,6′-bismaleimide-(2,2,4-trimethyl)hexane, for example, BMI-TMH manufactured by Daiwa Kasei Industry Co., Ltd. can be used. As the biphenylaralkyl-type maleimide resin, for example, MIR-3000 manufactured by Nippon Kayaku Co., Ltd. can be used. Examples of maleimide compounds having a phenylmaleimide group and an arylene structure substituted at the meta position in the molecule include a maleimide compound represented by the following Formula (13), and for example, MIR-5000 manufactured by Nippon Kayaku Co., Ltd. can be used.

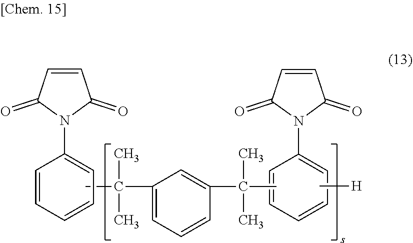

In Formula (13), s represents 1 to 5.

Examples of the maleimide compound (B1) having a phenylmaleimide group in the molecule include a maleimide compound having a phenylmaleimide group and an indane structure in the molecule. More specific examples of such a maleimide compound include a maleimide compound represented by the following Formula (14), still more specific examples thereof include a maleimide compound represented by the following Formula (14), where Ra represents a methyl group, q represents 2, and r represents 0.

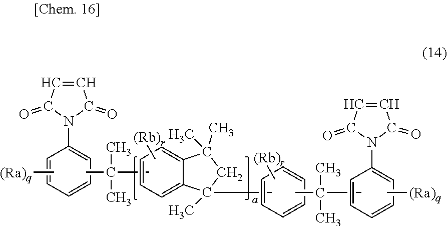

In Formula (14), Ra's are independent of each other. In other words, Ra's may be the same group as or different groups from each other, and for example, when q is 2 to 4, two to four Ra's bonded to the same benzene ring may be the same group as or different groups from each other. Ra represents an alkyl group having 1 to 10 carbon atoms, an alkyloxy group having 1 to 10 carbon atoms, an alkylthio group having 1 to 10 carbon atoms, an aryl group having 6 to 10 carbon atoms, an aryloxy group having 6 to 10 carbon atoms, an arylthio group having 6 to 10 carbon atoms, a cycloalkyl group having 3 to 10 carbon atoms, a halogen atom, a nitro group, a hydroxyl group, or a mercapto group. Rb's each independently represent an alkyl group having 1 to 10 carbon atoms, an alkyloxy group having 1 to 10 carbon atoms, an alkylthio group having 1 to 10 carbon atoms, an aryl group having 6 to 10 carbon atoms, an aryloxy group having 6 to 10 carbon atoms, an arylthio group having 6 to 10 carbon atoms, a cycloalkyl group having 3 to 10 carbon atoms, a halogen atom, a nitro group, a hydroxyl group, or a mercapto group. q represents 0 to 4. r represents 0 to 3. a represents 0.95 to 10.

### Maleimide Compound (B2) having Aliphatic Hydrocarbon Group having 11 or More Carbon Atoms in Molecule

The maleimide compound (B2) having an aliphatic hydrocarbon group having 11 or more carbon atoms in the molecule is not particularly limited as long as it is a maleimide compound having an aliphatic hydrocarbon group having 11 or more carbon atoms in the molecule, and examples thereof include a compound having an aliphatic hydrocarbon group having 11 or more carbon atoms in the molecule but not having a phenylmaleimide group in the molecule. The aliphatic hydrocarbon group is not particularly limited as long as it has 11 or more carbon atoms, and has preferably 20 or more carbon atoms, more preferably 30 or more carbon atoms. Such an aliphatic hydrocarbon group may be linear, may have a branched structure in the group, or may have an alicyclic structure in the group.

Examples of the maleimide compound (B2) having an aliphatic hydrocarbon group having 11 or more carbon atoms in the molecule include maleimide compounds represented by the following Formulas (15) to (18). A commercial product can be used as such a maleimide compound. Specifically, as the maleimide compound represented by the following Formula (15), for example, BMI-1500 manufactured by Desingner Molercules Inc. can be used. As the maleimide compound represented by the following Formula (16), for example, BMI-1700 manufactured by Desingner Molercules Inc. can be used. As the maleimide compound represented by the following Formula (17), for example, BMI-689 manufactured by Desingner Molercules Inc. can be used. As the maleimide compound represented by the following Formula (18), for example, BMI-3000 manufactured by Desingner Molercules Inc. can be used.

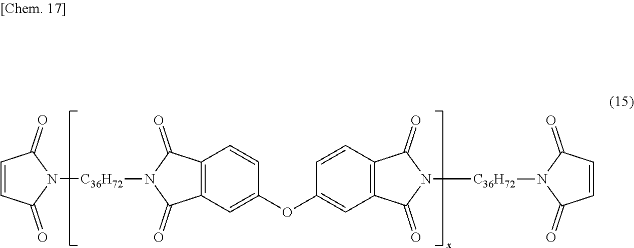

In Formula (15), x, which is a repeating unit, represents 1 to 10.

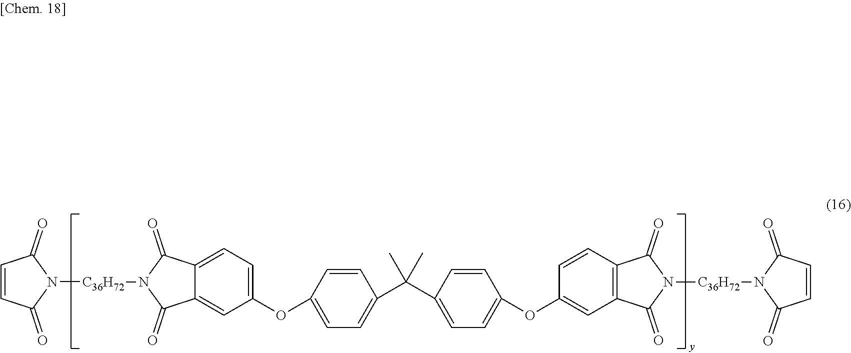

In Formula (16), y, which is a repeating unit, represents 1 to 10.

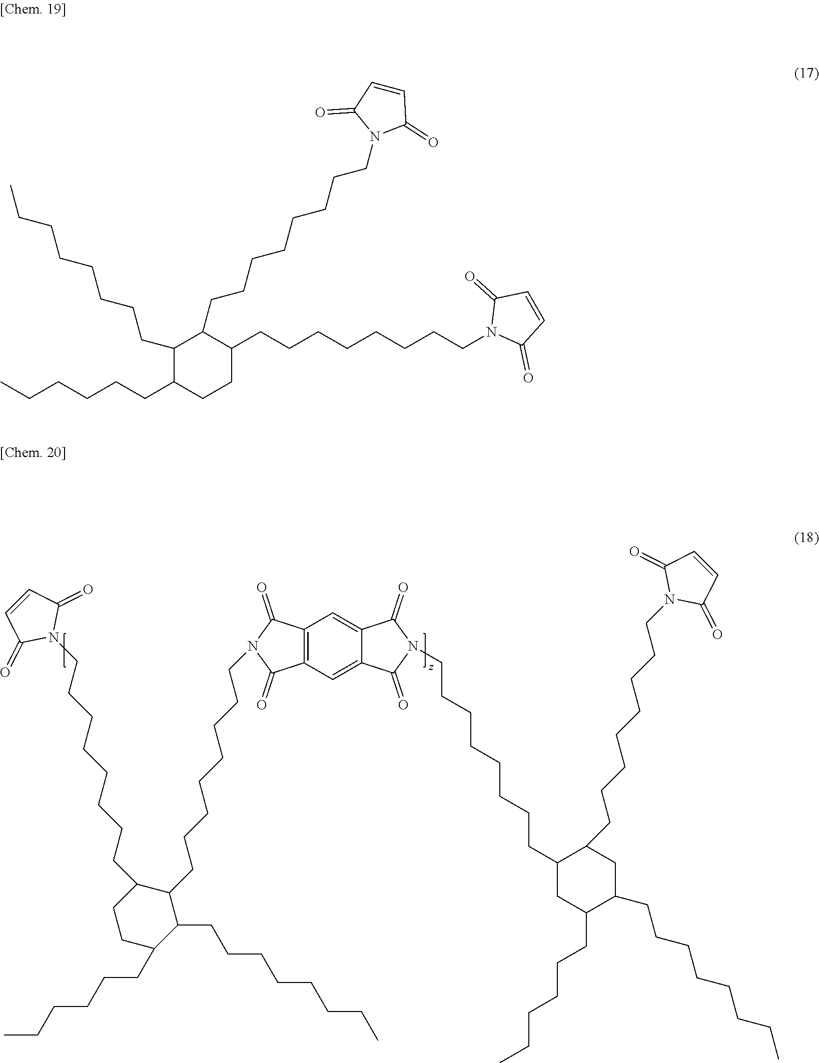

In Formula (18), z, which is a repeating unit, represents 1 to 10.

The weight average molecular weight (Mw) of the maleimide compound (B2) having an aliphatic hydrocarbon group having 11 or more carbon atoms in the molecule is preferably 500 to 4000. When the maleimide compound (B2) has such a molecular weight, the dielectric loss tangent is lower, the melt viscosity of the obtained resin composition is lower, and superior moldability is acquired. Here, the weight average molecular weight may be measured by a general molecular weight measurement method, and specific examples thereof include a value measured by gel permeation chromatography (GPC).

The maleimide compounds (B) may be used singly or in combination of two or more kinds thereof.

### Ceramic Particles (C)

The ceramic particles (C) are not particularly limited as long as they are ceramic particles including aluminum titanate particles (C1). In other words, the ceramic particles (C) may be ceramic particles including the aluminum titanate particles (C1) and ceramic particles (C2) other than the aluminum titanate particles (C1), or may be ceramic particles composed of the aluminum titanate particles (C1).

The aluminum titanate particles (C1) are not particularly limited, and examples thereof include aluminum titanate particles obtained by general synthesis methods such as a precipitation method, a solid phase method, and an electrofusion method.

The average particle size of the aluminum titanate particles (C1) is not particularly limited, but is preferably, for example, 0.1 to 10 μm, more preferably 0.5 to 5 μm. When the aluminum titanate particles (C1) have such a particle size, it is possible to further increase the relative dielectric constant while further suppressing an increase in the dielectric loss tangent of a cured product of the obtained resin composition. Here, the average particle size is the volume average particle size, and examples thereof include volume-based cumulative 50% diameter (D50). Specific examples thereof include the particle size (D50) where the cumulative particle size distribution from the small particle size side is 50% (based on volume) in the particle size distribution measured by a general laser diffraction/scattering method (volume-based cumulative 50% diameter in laser diffraction/scattering particle size distribution measurement).

The specific gravity of the aluminum titanate particles (C1) is not particularly limited, but for example, is preferably 3 to 4 g/cm³.

The ceramic particles (C2) other than the aluminum titanate particles (C1) are not particularly limited. Examples of the ceramic particles (C2) include strontium titanate particles, calcium titanate particles, barium titanate particles, magnesium titanate particles, zinc titanate particles, lanthanum titanate particles, neodymium titanate particles, titanium dioxide particles, aluminum oxide particles, and silica particles. Among these, strontium titanate particles, calcium titanate particles, barium titanate particles, magnesium titanate particles, titanium dioxide particles, aluminum oxide particles and silica particles are preferable, and strontium titanate particles, calcium titanate particles, titanium dioxide particles, and aluminum oxide particles are more preferable. By using these in combination with the aluminum titanate particles (C1), the relative dielectric constant of a cured product of the obtained resin composition can be further increased. The ceramic particles (C2) may be used singly or in combination of two or more kinds thereof.

The average particle size of the ceramic particles (C2) is not particularly limited. The average particle size of the ceramic particles (C2) also varies depending on the kind and the like of the ceramic particles (C2), but for example, is preferably 0.1 to 10 μm, more preferably 0.3 to 5 μm. Here, the average particle size is the volume average particle size as described above, and examples thereof include volume-based cumulative 50% diameter (D50) in the laser diffraction/scattering particle size distribution measurement. The specific gravity of the ceramic particles (C2) is not particularly limited. The specific gravity of the ceramic particles (C2) also varies depending on the kind and the like of the ceramic particles (C2), but is preferably 3 to 7 g/cm³.

The ceramic particles (C) may be ceramic particles subjected to surface treatment or may be ceramic particles not subjected to surface treatment. The ceramic particles (C) may be, for example, a combination of the aluminum titanate particles (C1) subjected to surface treatment and the ceramic particles (C2) not subjected to surface treatment, or may be a combination of the aluminum titanate particles (C1) not subjected to surface treatment and the ceramic particles ((2) subjected to surface treatment. Examples of the surface treatment include treatment with coupling agents such as a silane coupling agent and a titanium coupling agent. The coupling agent may be contained as a coupling agent covered on the ceramic particles (C) for surface treatment in advance, or may be contained in the resin composition.

Examples of the silane coupling agent and titanium coupling agent include coupling agents having at least one functional group selected from the group consisting of a vinyl group, a styryl group, a methacryloyl group, an acryloyl group, a phenylamino group, an isocyanurate group, a ureido group, a mercapto group, an isocyanate group, an epoxy group, and an acid anhydride group. In other words, examples of the silane coupling agent and titanium coupling agent include compounds having at least one of a vinyl group, a styryl group, a methacryloyl group, an acryloyl group, a phenylamino group, an isocyanurate group, a ureido group, a mercapto group, an isocyanate group, an epoxy group, or an acid anhydride group as a reactive functional group, and further a hydrolyzable group such as a methoxy group or an ethoxy group.

Examples of the silane coupling agent include vinyltriethoxysilane and vinyltrimethoxysilane as those having a vinyl group. Examples of the silane coupling agent include p-styryltrimethoxysilane and p-styryltriethoxysilane as those having a styryl group. Examples of the silane coupling agent include 3-methacryloxypropyltrimethoxysilane, 3-methacryloxypropylmethyldimethoxysilane, 3-methacryloxypropyltriethoxysilane, 3-methacryloxypropylmethyldiethoxysilane, and 3-methacryloxypropylethyldiethoxysilane as those having a methacryloyl group. Examples of the silane coupling agent include 3-acryloxypropyltrimethoxysilane and 3-acryloxypropyltriethoxysilane as those having an acryloyl group. Examples of the silane coupling agent include N-phenyl-3-aminopropyltrimethoxysilane and N-phenyl-3-aminopropyltriethoxysilane as those having a phenylamino group. Examples of the titanium coupling agent include isopropyl (N-ethylaminoethylamino) titanate, isopropyl triisostearoyl titanate, titanium di(dioctylpyrophosphate)oxyacctate, tetraisopropyldi(dioctylphosphite)titanate, and neoalkoxytri(p-N-(β-aminoethyl)aminophenyl)titanate. These coupling agents may be used singly or in combination of two or more kinds thereof.

### Content

The content of the ceramic particles (C) is preferably 100 to 250 parts by mass, more preferably 100 to 200 parts by mass with respect to 100 parts by mass of the sum of the polyphenylene ether compound (A) and the maleimide compound (B). In other words, the total content of the polyphenylene ether compound (A) and the maleimide compound (B) is preferably 40 to 100 parts by mass, more preferably 40 to 80 parts by mass with respect to 100 parts by mass of the ceramic particles (C). The sum of the polyphenylene ether compound (A) and the maleimide compound (B) is the content of the one contained in a case where only one of the polyphenylene ether compound (A) and the maleimide compound (B) is contained. For example, in the case of a resin composition containing the polyphenylene ether compound (A) but not containing the maleimide compound (B), the sum of the polyphenylene ether compound (A) and the maleimide compound (B) refers to the content of the polyphenylene ether compound (A). When the content of the ceramic particles (C) is too low, the effect exerted by the ceramic particles (C) is insufficient, and for example, there is a tendency that heat resistance, flame retardancy, and the like are not sufficiently enhanced. When the content of the ceramic particles (C) is too high, the melt viscosity of the obtained resin composition is too high and moldability tends to decrease. Hence, when the content of the ceramic particles (C) is in the above range, a cured product having a high relative dielectric constant and a low dielectric loss tangent is suitably obtained as cured products of the resin composition and prepreg obtained.

The content of the aluminum titanate particles (C1) is preferably 5 to 100 parts by mass, more preferably 5 to 90 parts by mass, still more preferably 10 to 90 parts by weight, particularly preferably 20 to 90 parts by weight with respect to 100 parts by mass of the ceramic particles (C). When the content of the aluminum titanate particles (C1) is too low, the effect exerted by the aluminum titanate particles (C1) is insufficient. In other words, when the content of the aluminum titanate particles (C1) decreases, the content of the ceramic particles (C2) other than the aluminum titanate particles (C1) increases, and the dielectric loss tangent also tends to increase even though the relative dielectric constant of a cured product of the resin composition can be increased. Hence, when the content of the aluminum titanate particles (C1) is in the above range, a cured product having a higher relative dielectric constant and a lower dielectric loss tangent is obtained.

### Other Components

The resin composition may contain components (other components) other than the polyphenylene ether compound (A), the maleimide compound (B), and the ceramic particles (C), if necessary, as long as the effects of the present invention are not impaired. As the other components contained in the resin composition according to the present embodiment, for example, additives such as a curing agent, a reaction initiator, a reaction accelerator, a catalyst, a polymerization retarder, a polymerization inhibitor, a dispersant, a leveling agent, a coupling agent, an antifoaming agent, an antioxidant, a heat stabilizer, an antistatic agent, an ultraviolet absorber, a dye or a pigment, and a lubricant may be further contained.

The resin composition according to the present embodiment may contain a curing agent that reacts with the polyphenylene ether compound (A) to contribute to curing of the resin composition, if necessary, in the case of a resin composition containing the polyphenylene ether compound (A) as long as the effects of the present invention are not impaired. The resin composition may contain a curing agent that reacts with the maleimide compound (B) to contribute to curing of the resin composition in the case of a resin containing the maleimide compound (B). Examples of the curing agent include an epoxy compound, a methacrylate compound, an acrylate compound, a cyanate ester compound, an active ester compound, a benzoxazine compound, and an allyl compound.

The epoxy compound is a compound having an epoxy group in the molecule, and specific examples thereof include a bisphenol type epoxy compound such as a bisphenol A type epoxy compound, a phenol novolac type epoxy compound, a cresol novolac type epoxy compound, a dicyclopentadiene type epoxy compound, a bisphenol A novolac type epoxy compound, a biphenylaralkyl type epoxy compound, and a naphthalene ring-containing epoxy compound. The epoxy compound also includes an epoxy resin, which is a polymer of each of the epoxy compounds.

The methacrylate compound is a compound having a methacryloyl group in the molecule, and examples thereof include a monofunctional methacrylate compound having one methacryloyl group in the molecule and a polyfunctional methacrylate compound having two or more methacryloyl groups in the molecule. Examples of the monofunctional methacrylate compound include methyl methacrylate, ethyl methacrylate, propyl methacrylate, and butyl methacrylate. Examples of the polyfunctional methacrylate compound include dimethacrylate compounds such as tricyclodecanedimethanol dimethacrylate (DCP).

The acrylate compound is a compound having an acryloyl group in the molecule, and examples thereof include a monofunctional acrylate compound having one acryloyl group in the molecule and a polyfunctional acrylate compound having two or more acryloyl groups in the molecule. Examples of the monofunctional acrylate compound include methyl acrylate, ethyl acrylate, propyl acrylate, and butyl acrylate. Examples of the polyfunctional acrylate compound include diacrylate compounds such as tricyclodecanedimethanol diacrylate.

The cyanate ester compound is a compound having a cyanato group in the molecule, and examples thereof include 2,2-bis(4-cyanatophenyl)propane, bis(3,5-dimethyl-4-cyanatophenyl)methane, and 2,2-bis(4-cyanatophenyl)ethane.

The active ester compound is a compound having an ester group exhibiting high reaction activity in the molecule, and examples thereof include a benzenecarboxylic acid active ester, a benzenedicarboxylic acid active ester, a benzenetricarboxylic acid active ester, a benzenetetracarboxylic acid active ester, a naphthalenecarboxylic acid active ester, a naphthalenedicarboxylic acid active ester, a naphthalenetricarboxylic acid active ester, a naphthalenetetracarboxylic acid active ester, a fluorenecarboxylic acid active ester, a fluorenedicarboxylic acid active ester, a fluorenetricarboxylic acid active ester, and a fluorenetetracarboxylic acid active ester.

The benzoxazine compound is a compound having a benzoxazine ring in the molecule, and examples thereof include a benzoxazine resin.

The allyl compound is a compound having an allyl group in the molecule, and examples thereof include a triallyl isocyanurate compound such as triallyl isocyanurate (TAIC), a diallyl bisphenol compound, and diallyl phthalate (DAP).

As the curing agent, the above curing agents may be used singly or in combination of two or more kinds thereof.

The weight average molecular weight of the curing agent is not particularly limited and is, for example, preferably 100 to 5000, more preferably 100 to 4000, still more preferably 100 to 3000. When the weight average molecular weight of the curing agent is too low, the curing agent may easily volatilize from the compounding component system of the resin composition. When the weight average molecular weight of the curing agent is too high, the viscosity of the varnish of the resin composition and the melt viscosity at the time of heat molding may be too high. Hence, a resin composition imparting superior heat resistance to the cured product is obtained when the weight average molecular weight of the curing agent is within such a range. It is considered that this is because the resin composition can be suitably cured. Here, the weight average molecular weight may be measured by a general molecular weight measurement method, and specific examples thereof include a value measured by gel permeation chromatography (GPC).

In the curing agent, the average number (number of functional groups) of the functional groups, which contribute to the reaction during curing of the resin composition, per one molecule of the curing agent varies depending on the weight average molecular weight of the curing agent but is, for example, preferably 1 to 20, more preferably 2 to 18. When this number of functional groups is too small, sufficient heat resistance of the cured product tends to be hardly attained. When the number of functional groups is too large, the reactivity is too high and, for example, troubles such as a decrease in the storage stability of the resin composition or a decrease in the fluidity of the resin composition may occur.

As described above, the resin composition according to the present embodiment may contain a reaction initiator. The curing reaction can proceed even though the resin composition does not contain a reaction initiator. However, a reaction initiator may be added since there is a case where it is difficult to raise the temperature until curing proceeds depending on the process conditions. The reaction initiator is not particularly limited as long as it can promote the curing reaction of the resin composition, and examples thereof include a peroxide and an organic azo compound. Examples of the peroxide include dicumyl peroxide, α,α′-bis(t-butylperoxy-m-isopropyl)benzene, 2,5-dimethyl-2,5-di(t-butylperoxy)-3-hexyne, and benzoyl peroxide. Examples of the organic azo compound include azobisisobutyronitrile. A metal carboxylate can be concurrently used if necessary. By doing so, the curing reaction can be further promoted. Among these, α,α′-bis(t-butylperoxy-m-isopropyl)benzene is preferably used. α,α′-Bis(t-butylperoxy-m-isopropyl)benzene has a relatively high reaction initiation temperature and thus can suppress the promotion of the curing reaction at the time point at which curing is not required, for example, at the time of prepreg drying, and can suppress a decrease in storage stability of the resin composition. α,α′-Bis(t-butylperoxy-m-isopropyl)benzene exhibits low volatility, thus does not volatilize at the time of prepreg drying and storage, and exhibits favorable stability. The reaction initiators may be used singly or in combination of two or more thereof.

As described above, the resin composition according to the present embodiment may contain a coupling agent. The coupling agent may be contained in the resin composition or may be contained as a coupling agent covered on the ceramic particles (C) contained in the resin composition for surface treatment in advance. Among these, it is preferable that the coupling agent is contained as a coupling agent covered on the ceramic particles (C) for surface treatment in advance, and it is more preferable that the coupling agent is contained as a coupling agent covered on the ceramic particles (C) for surface treatment in advance and further is also contained in the resin composition. In the case of a prepreg, the coupling agent may be contained in the prepreg as a coupling agent covered on the fibrous base material for surface treatment in advance. Examples of the coupling agent include those similar to the coupling agents used in the surface treatment of the ceramic particles (C) described above.

As described above, the resin composition according to the present embodiment may contain a flame retardant. The flame retardancy of a cured product of the resin composition can be enhanced by containing a flame retardant. The flame retardant is not particularly limited. Specifically, in the field in which halogen-based flame retardants such as bromine-based flame retardants are used, for example, ethylenedipentabromobenzene, ethylenebistetrabromoimide, decabromodiphenyloxide, and tetradecabromodiphenoxybenzene that have a melting point of 300° C. or more, and a bromostyrene-based compound that reacts with the polymerizable compound are preferable. It is considered that the elimination of halogen at a high temperature and the decrease in heat resistance can be suppressed by the use of a halogen-based flame retardant. There is a case where a flame retardant containing phosphorus (phosphorus-based flame retardant) is used in fields required to be halogen-free. The phosphorus-based flame retardant is not particularly limited, and examples thereof include a phosphate ester-based flame retardant, a phosphazene-based flame retardant, a bis(diphenylphosphine oxide)-based flame retardant, and a phosphinate-based flame retardant. Specific examples of the phosphate ester-based flame retardant include a condensed phosphate ester such as dixylenyl phosphate. Specific examples of the phosphazene-based flame retardant include phenoxyphosphazene. Specific examples of the bis(diphenylphosphine oxide)-based flame retardant include xylylenebis(diphenylphosphine oxide). Specific examples of the phosphinate-based flame retardant include metal phosphinates such as an aluminum dialkyl phosphinate. As the flame retardant, the respective flame retardants exemplified may be used singly or in combination of two or more kinds thereof.

### Use

The resin composition is used when a prepreg is manufactured, as described later. The resin composition is used when a resin layer included in a metal foil with resin and a film with resin is formed and when an insulating layer included in a metal-clad laminate and a wiring board is formed.

The relative dielectric constant of a cured product of the resin composition is preferably 4 or more, more preferably 5 or more at a frequency of 10 GHz. The dielectric loss tangent of a cured product of the resin composition is preferably 0.0055 or less, more preferably 0.005 or less at a frequency of 10 GHz. The relative dielectric constant and dielectric loss tangent here are the relative dielectric constant and dielectric loss tangent of a cured product of the resin composition at a frequency of 10 GHz, and examples thereof include the relative dielectric constant and dielectric loss tangent of a cured product of the resin composition at a frequency of 10 GHz measured by the cavity perturbation method. The resin composition thus affords a cured product having a high relative dielectric constant and a low dielectric loss tangent. For this reason, the resin composition is suitably used to form an insulating layer included in a wiring board compatible with high frequencies, such as wiring boards for antennas and antenna boards for millimeter-wave radar. In other words, the resin composition is suitable for manufacture of wiring boards compatible with high frequencies.

The wiring board compatible with high frequencies is not particularly limited, but examples thereof include a wiring board having a small distance between wirings, a wiring board having a small wiring width, and a multilayer wiring board.

The minimum value of the distance between wirings is not particularly limited, but is preferably 50 μm or less, more preferably 30 μm or less. In other words, the resin composition is suitably used when a wiring board having such a small distance between wirings is manufactured. When the minimum value of the distance between wirings is 50 μm or less as well, speeding up of signal transmission can be realized and the signal transmission loss can be decreased. By fabricating such a wiring board having a minimum value of distance between wirings of 50 μm or less, that is, a substrate equipped with wiring that includes a place where the distance between wirings is 50 μm or less at least at a part, the density of wiring in the substrate can be increased, and for example, the wiring board can be miniaturized. Here, the distance between wirings is the distance between adjacent wirings.

The minimum value of the wiring width is not particularly limited, but is preferably 50 μm or less, more preferably 30 μm or less. In other words, the resin composition is suitably used when a wiring board having such a small wiring width is manufactured. When the minimum value of the wiring width is 50 μm or less as well, speeding up of signal transmission can be realized and the signal transmission loss can be decreased. By fabricating such a wiring board having a minimum value of wiring width of 50 μm or less, that is, a substrate equipped with wiring that includes a place where the wiring width is 50 μm or less at least at a part, the density of wiring in the substrate can be increased, and for example, the wiring board can be miniaturized. Here, the wiring width is the distance of the wiring perpendicular to the longitudinal direction.

The wiring board may be a multilayer wiring board having two or more circuit layers, and the resin composition according to the present embodiment can be suitably used as an interlayer insulating material for the multilayer wiring board. The wiring board is not particularly limited, but may be, for example, a multilayer wiring board having two or more circuit layers and provided with a wiring pattern in which the distance between wirings is 50 μm or less at least at a part. The resin composition according to the present embodiment is not particularly limited, but is preferably used as an insulating material for an insulating layer of a high multilayer wiring board having 5 or more circuit layers or 10 or more circuit layers. The density of wiring in a multilayer wiring board can be thus increased, and speeding up of signal transmission can be realized and the signal transmission loss can be decreased in such a multilayer wiring board as well. By the wiring board, speeding up of signal transmission can be realized and the signal transmission loss can be decreased in a case where conductive through holes are equipped, a case where conductive vias are equipped, or a case where conductive through holes and conductive vias are both equipped in a multilayer wiring board.

The coefficient of thermal expansion of a cured product of the resin composition is preferably 14 ppm/° C. or less, more preferably 13 ppm/° C. or less. The strength (copper foil peel strength) is preferably 0.45 N/mm or more, more preferably 0.5 N/mm or more when the metal foil (copper foil) clad to the surface of a metal-clad laminate including a cured product of the resin composition is peeled off. The resin composition according to the present embodiment affords a cured product having not only a high relative dielectric constant and a low dielectric loss tangent but also such a low coefficient of thermal expansion and such excellent adhesive properties to a metal foil.

### Production Method

The method for producing the resin composition is not particularly limited as long as the resin composition can be produced, and examples thereof include a method in which at least one of the polyphenylene ether compound (A) and the maleimide compound (B), and the ceramic particles (C) are mixed together so as to have predetermined contents. Examples thereof include the method to be described later in the case of obtaining a varnish-like composition containing an organic solvent.

Moreover, by using the resin composition according to the present embodiment, a prepreg, a metal-clad laminate, a wiring board, a metal foil with resin, and a film with resin can be obtained as described below.

### Prepreg

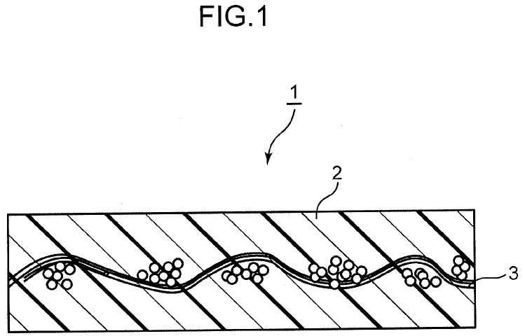

FIG. 1 is a schematic sectional view illustrating an example of a prepreg 1 according to an embodiment of the present invention.

As illustrated in FIG. 1, the prepreg 1 according to the present embodiment includes the resin composition or a semi-cured product 2 of the resin composition and a fibrous base material 3. This prepreg 1 includes the resin composition or the semi-cured product 2 of the resin composition and the fibrous base material 3 present in the resin composition or the semi-cured product 2 of the resin composition.

In the present embodiment, the semi-cured product is in a state in which the resin composition has been cured to an extent that the resin composition can be further cured. In other words, the semi-cured product is the resin composition in a semi-cured state (B-staged). For example, when a resin composition is heated, the viscosity of the resin composition first gradually decreases, then curing starts, and the viscosity gradually increases. In such a case, the semi-cured state includes a state in which the viscosity has started to increase but curing is not completed, and the like.

The prepreg to be obtained using the resin composition according to the present embodiment may include a semi-cured product of the resin composition as described above or include the uncured resin composition itself. In other words, the prepreg may be a prepreg including a semi-cured product of the resin composition (the resin composition in B stage) and a fibrous base material or a prepreg including the resin composition before being cured (the resin composition in A stage) and a fibrous base material. The resin composition or a semi-cured product of the resin composition may be one obtained by drying or heating and drying the resin composition.

When a prepreg is manufactured, the resin composition 2 is often prepared in a varnish form and used in order to be impregnated into the fibrous base material 3 which is a base material for forming the prepreg. In other words, the resin composition 2 is usually a resin varnish prepared in a varnish form in many cases. Such a varnish-like resin composition (resin varnish) is prepared, for example, as follows.

First, the respective components which can be dissolved in an organic solvent are introduced into and dissolved in an organic solvent. At this time, heating may be performed if necessary. Thereafter, components which are used if necessary but are not dissolved in the organic solvent are added to and dispersed in the solution until a predetermined dispersion state is achieved using a ball mill, a bead mill, a planetary mixer, a roll mill or the like, whereby a varnish-like resin composition is prepared. The organic solvent used here is not particularly limited as long as it dissolves the polyphenylene ether compound (A), the maleimide compound (B) and the like and does not inhibit the curing reaction. Specific examples thereof include toluene and methyl ethyl ketone (MEK).

Specific examples of the fibrous base material include glass cloth, aramid cloth, polyester cloth, a glass nonwoven fabric, an aramid nonwoven fabric, a polyester nonwoven fabric, pulp paper, and linter paper. When glass cloth is used, a laminate exhibiting excellent mechanical strength is obtained, and glass cloth subjected to flattening is particularly preferable. Specific examples of the flattening include a method in which glass cloth is continuously pressed at an appropriate pressure using a press roll to flatly compress the yarn. The thickness of the generally used fibrous base material is, for example, 0.01 mm or more and 0.3 mm or less. The glass fiber constituting the glass cloth is not particularly limited, and examples thereof include Q glass, NE glass, E glass, S glass, T glass, L glass, and L2 glass. The surface of the fibrous base material may be subjected to a surface treatment with a silane coupling agent. The silane coupling agent is not particularly limited, but examples thereof include a silane coupling agent having at least one selected from the group consisting of a vinyl group, an acryloyl group, a methacryloyl group, a styryl group, an amino group, and an epoxy group in the molecule.

The method for manufacturing the prepreg is not particularly limited as long as the prepreg can be manufactured. Specifically, when the prepreg is manufactured, the resin composition according to the present embodiment described above is often prepared in a varnish form and used as a resin varnish as described above.

Specific examples of the method for manufacturing the prepreg 1 include a method in which the fibrous base material 3 is impregnated with the resin composition 2, for example, the resin composition 2 prepared in a varnish form, and then dried. The fibrous base material 3 is impregnated with the resin composition 2 by dipping, coating, and the like. If necessary, the impregnation can be repeated a plurality of times. Moreover, at this time, it is also possible to finally adjust the composition and impregnated amount to the desired composition and impregnated amount by repeating impregnation using a plurality of resin compositions having different compositions and concentrations.

The fibrous base material 3 impregnated with the resin composition (resin varnish) 2 is heated under desired heating conditions, for example, at 40° C. or more and 180° C. or less for 1 minute or more and 10 minutes or less. By heating, the prepreg 1 before being cured (A-stage) or in a semi-cured state (B-stage) is obtained. By the heating, the organic solvent can be decreased or removed by being volatilized from the resin varnish.

The resin composition according to the present embodiment is a resin composition, which affords a cured product having a high relative dielectric constant and a low dielectric loss tangent. For this reason, the prepreg including this resin composition or a semi-cured product of this resin composition is a prepreg, which affords a cured product having a high relative dielectric constant and a low dielectric loss tangent. Moreover, a wiring board including an insulating layer containing a cured product, which has a high relative dielectric constant and a low dielectric loss tangent, can be suitably manufactured using this prepreg. As a cured product obtained from the resin composition, there is obtained a cured product having not only a high relative dielectric constant and a low dielectric loss tangent but also a low coefficient of thermal expansion and excellent adhesive properties to a metal foil. For this reason, a cured product having a low coefficient of thermal expansion and excellent adhesive properties to a metal foil is obtained as a cured product of the prepreg. Specifically, the relative dielectric constant of a cured product of the prepreg is preferably 4 or more, more preferably 5 or more at a frequency of 10 GHz. The dielectric loss tangent of a cured product of the prepreg is preferably 0.0055 or less, more preferably 0.005 or less at a frequency of 10 GHz. The relative dielectric constant and dielectric loss tangent here are the relative dielectric constant and dielectric loss tangent of a cured product of the prepreg at a frequency of 10 GHz, and examples thereof include the relative dielectric constant and dielectric loss tangent of a cured product of the prepreg at a frequency of 10 GHz measured by the cavity perturbation method. The coefficient of thermal expansion of a cured product of the prepreg is preferably 14 ppm/° C. or less, more preferably 13 ppm/° C. or less. The strength (copper foil peel strength) is preferably 0.45 N/mm or more, more preferably 0.5 N/mm or more when the metal foil (copper foil) clad to the surface of a metal-clad laminate including a cured product of the prepreg is peeled off. Hence, a wiring board obtained from this prepreg includes an insulating layer having not only a high relative dielectric constant and a low dielectric loss tangent but also a low coefficient of thermal expansion and excellent adhesive properties to a metal foil.

### Metal-Clad Laminate

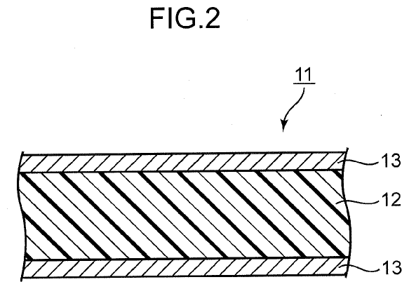

FIG. 2 is a schematic sectional view illustrating an example of a metal-clad laminate 11 according to an embodiment of the present invention.

As illustrated in FIG. 2, the metal-clad laminate 11 according to the present embodiment includes an insulating layer 12 containing a cured product of the resin composition and a metal foil 13 provided on the insulating layer 12. Examples of the metal-clad laminate 11 include a metal-clad laminate including an insulating layer 12 containing a cured product of the prepreg 1 illustrated in FIG. 1 and a metal foil 13 to be laminated together with the insulating layer 12. The insulating layer 12 may be formed of a cured product of the resin composition or a cured product of the prepreg. In addition, the thickness of the metal foil 13 varies depending on the performance and the like to be required for the finally obtained wiring board and is not particularly limited. The thickness of the metal foil 13 can be appropriately set depending on the desired purpose and is preferably, for example, 0.2 to 70 μm. Examples of the metal foil 13 include a copper foil and an aluminum foil, and the metal foil 13 may be a copper foil with carrier which includes a release layer and a carrier for the improvement in handleability in a case where the metal foil is thin.

The method for manufacturing the metal-clad laminate 11 is not particularly limited as long as the metal-clad laminate 11 can be manufactured. Specific examples thereof include a method in which the metal-clad laminate 11 is fabricated using the prepreg 1. Examples of this method include a method in which the double-sided metal foil-clad or single-sided metal foil-clad laminate 11 is fabricated by stacking one sheet or a plurality of sheets of prepreg 1, further stacking the metal foil 13 such as a copper foil on both or one of upper and lower surfaces of the prepregs 1, and laminating and integrating the metal foils 13 and prepregs 1 by heating and pressing. In other words, the metal-clad laminate 11 is obtained by laminating the metal foil 13 on the prepreg 1 and then performing heating and pressing. The heating and pressing conditions can be appropriately set depending on the thickness of the metal-clad laminate 11, the kind of the resin composition contained in the prepreg 1, and the like. For example, it is possible to set the temperature to 170° C. to 230° C., the pressure to 2 to 4 MPa, and the time to 60 to 150 minutes. Moreover, the metal-clad laminate may be manufactured without using a prepreg. Examples thereof include a method in which a varnish-like resin composition is applied on a metal foil to form a layer containing the resin composition on the metal foil and then heating and pressing is performed.

The resin composition according to the present embodiment is a resin composition, which affords a cured product having a high relative dielectric constant and a low dielectric loss tangent. For this reason, the metal-clad laminate including an insulating layer containing a cured product of this resin composition is a metal-clad laminate including an insulating layer containing a cured product, which has a high relative dielectric constant and a low dielectric loss tangent. Moreover, a wiring board including an insulating layer containing a cured product, which has a high relative dielectric constant and a low dielectric loss tangent, can be suitably manufactured using this metal-clad laminate. As a cured product obtained from the resin composition, there is obtained a cured product having not only a high relative dielectric constant and a low dielectric loss tangent but also a low coefficient of thermal expansion and excellent adhesive properties to a metal foil. For this reason, a wiring board obtained using a metal-clad laminate including an insulating layer containing a cured product of the resin composition includes an insulating layer having not only a high relative dielectric constant and a low dielectric loss tangent but also a low coefficient of thermal expansion and excellent adhesive properties to a metal foil.

### Wiring Board

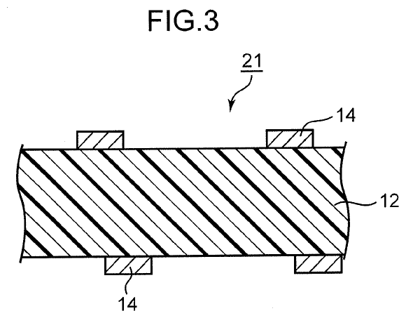

FIG. 3 is a schematic sectional view illustrating an example of a wiring board 21 according to an embodiment of the present invention.

As illustrated in FIG. 3, the wiring board 21 according to the present embodiment includes an insulating layer 12 containing a cured product of the resin composition and wiring 14 provided on the insulating layer 12. Examples of the wiring board 21 include a wiring board formed of an insulating layer 12 obtained by curing the prepreg 1 illustrated in FIG. 1 and wiring 14 which is laminated together with the insulating layer 12 and is formed by partially removing the metal foil 13. The insulating layer 12 may be formed of a cured product of the resin composition or a cured product of the prepreg. The wiring board 21 is preferably a wiring board compatible with high frequencies. In other words, as the wiring board compatible with high frequencies, for example, a wiring board having a small distance between wirings, a wiring board having a small wiring width, a multilayer wiring board and the like are preferable, and a wiring board is more preferable in which the distance between wirings, the wiring width, and the number of layers are in the ranges described above.

The method for manufacturing the wiring board 21 is not particularly limited as long as the wiring board 21 can be manufactured. Specific examples thereof include a method in which the wiring board 21 is fabricated using the prepreg 1. Examples of this method include a method in which the wiring board 21, in which wiring is provided as a circuit on the surface of the insulating layer 12, is fabricated by forming wiring through etching and the like of the metal foil 13 on the surface of the metal-clad laminate 11 fabricated in the manner described above. In other words, the wiring board 21 is obtained by partially removing the metal foil 13 on the surface of the metal-clad laminate 11 and thus forming a circuit. Examples of the method for forming a circuit include circuit formation by a semi-additive process (SAP) or a modified semi-additive process (MSAP) in addition to the method described above. The wiring board 21 is a wiring board including the insulating layer 12 containing a cured product, which has a high relative dielectric constant and a low dielectric loss tangent. As a cured product obtained from the resin composition, there is obtained a cured product having not only a high relative dielectric constant and a low dielectric loss tangent but also a low coefficient of thermal expansion and excellent adhesive properties to a metal foil. For this reason, the wiring board includes an insulating layer having not only a high relative dielectric constant and a low dielectric loss tangent but also a low coefficient of thermal expansion and excellent adhesive properties to a metal foil.

The metal-clad laminate and the wiring board include the insulating layer as described above. Specifically, the insulating layer (the insulating layer included in the metal-clad laminate and the insulating layer included in the wiring board) is preferably the following insulating layer. The relative dielectric constant of the insulating layer is preferably 4 or more, more preferably 5 or more at a frequency of 10 GHz. The dielectric loss tangent of the insulating layer is preferably 0.0055 or less, more preferably 0.005 or less at a frequency of 10 GHz. The relative dielectric constant and dielectric loss tangent here are the relative dielectric constant and dielectric loss tangent of the insulating layer at a frequency of 10 GHz, and examples thereof include the relative dielectric constant and dielectric loss tangent of the insulating layer at a frequency of 10 GHz measured by the cavity perturbation method. The coefficient of thermal expansion of the insulating layer is preferably 14 ppm/° C. or less, more preferably 13 ppm/° C. or less. The strength (copper foil peel strength) when the metal foil (copper foil) is peeled off is preferably 0.45 N/mm or more, more preferably 0.5 N/mm or more in the case of a metal-clad laminate including the insulating layer. The strength (wiring peel strength) when the wiring is peeled off is preferably 0.45 N/mm or more, more preferably 0.5 N/mm or more in the case of a wiring board.

### Metal Foil with Resin

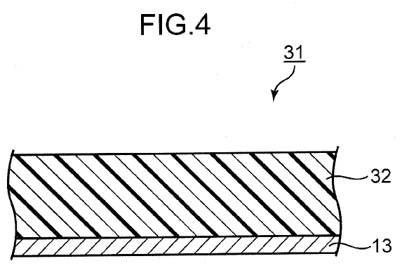

FIG. 4 is a schematic sectional view illustrating an example of a metal foil with resin 31 according to the present embodiment.

The metal foil with resin 31 according to the present embodiment includes a resin layer 32 containing the resin composition or a semi-cured product of the resin composition and a metal foil 13 as illustrated in FIG. 4. The metal foil with resin 31 includes the metal foil 13 on the surface of the resin layer 32. In other words, the metal foil with resin 31 includes the resin layer 32 and the metal foil 13 to be laminated together with the resin layer 32. The metal foil with resin 31 may include other layers between the resin layer 32 and the metal foil 13.

The resin layer 32 may contain a semi-cured product of the resin composition as described above or may contain the uncured resin composition. In other words, the metal foil with resin 31 may be a metal foil with resin including a resin layer containing a semi-cured product of the resin composition (the resin composition in B stage) and a metal foil or a metal foil with resin including a resin layer containing the resin composition before being cured (the resin composition in A stage) and a metal foil. The resin layer is only required to contain the resin composition or a semi-cured product of the resin composition and may or may not contain a fibrous base material. The resin composition or a semi-cured product of the resin composition may be one obtained by drying or heating and drying the resin composition. As the fibrous base material, those similar to the fibrous base materials of the prepreg can be used.

As the metal foil, metal foils used in metal-clad laminates or metal foils with resin can be used without limitation. Examples of the metal foil include a copper foil and an aluminum foil.

The metal foil with resin 31 may include a cover film and the like if necessary. By including a cover film, it is possible to prevent entry of foreign matter and the like. The cover film is not particularly limited, and examples thereof include a polyolefin film, a polyester film, a polymethylpentene film, and films formed by providing a release agent layer on these films.

The method for manufacturing the metal foil with resin 31 is not particularly limited as long as the metal foil with resin 31 can be manufactured. Examples of the method for manufacturing the metal foil with resin 31 include a method in which the varnish-like resin composition (resin varnish) is applied on the metal foil 13 and heated to manufacture the metal foil with resin 31. The varnish-like resin composition is applied on the metal foil 13 using, for example, a bar coater. The applied resin composition is heated under the conditions of, for example, 40° C. or more and 180° C. or less and 0.1 minute or more and 10 minutes or less. The heated resin composition is formed as the uncured resin layer 32 on the metal foil 13. By the heating, the organic solvent can be decreased or removed by being volatilized from the resin varnish.

The resin composition according to the present embodiment is a resin composition, which affords a cured product having a high relative dielectric constant and a low dielectric loss tangent. For this reason, the metal foil with resin including a resin layer containing this resin composition or a semi-cured product of this resin composition is a metal foil with resin including a resin layer, which affords a cured product having a high relative dielectric constant and a low dielectric loss tangent. Moreover, this metal foil with resin can be used when a wiring board including an insulating layer containing a cured product, which has a high relative dielectric constant and a low dielectric loss tangent, is manufactured. For example, by laminating the metal foil with resin on a wiring board, a multilayer wiring board can be manufactured. As a wiring board obtained using such a metal foil with resin, there is obtained a wiring board including an insulating layer containing a cured product, which has a high relative dielectric constant and a low dielectric loss tangent. As a cured product obtained from the resin composition, there is obtained a cured product having not only a high relative dielectric constant and a low dielectric loss tangent but also a low coefficient of thermal expansion and excellent adhesive properties to a metal foil. For this reason, a wiring board obtained using a metal foil with resin including a resin layer containing the resin composition or a semi-cured product of the resin composition includes an insulating layer having not only a high relative dielectric constant and a low dielectric loss tangent but also a low coefficient of thermal expansion and excellent adhesive properties to a metal foil.

### Film with Resin

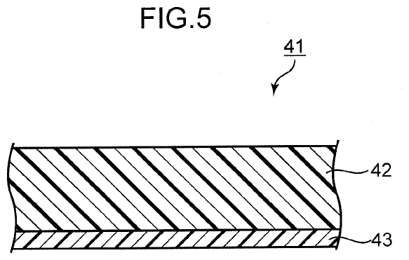

FIG. 5 is a schematic sectional view illustrating an example of a film with resin 41 according to the present embodiment.

The film with resin 41 according to the present embodiment includes a resin layer 42 containing the resin composition or a semi-cured product of the resin composition and a support film 43 as illustrated in FIG. 5. The film with resin 41 includes the resin layer 42 and the support film 43 to be laminated together with the resin layer 42. The film with resin 41 may include other layers between the resin layer 42 and the support film 43.

The resin layer 42 may contain a semi-cured product of the resin composition as described above or may contain the uncured resin composition. In other words, the film with resin 41 may be a film with resin including a resin layer containing a semi-cured product of the resin composition (the resin composition in B stage) and a support film or a film with resin including a resin layer containing the resin composition before being cured (the resin composition in A stage) and a support film. The resin layer is only required to contain the resin composition or a semi-cured product of the resin composition and may or may not contain a fibrous base material. The resin composition or a semi-cured product of the resin composition may be one obtained by drying or heating and drying the resin composition. As the fibrous base material, those similar to the fibrous base materials of the prepreg can be used.

As the support film 43, support films used in films with resin can be used without limitation. Examples of the support film include electrically insulating films such as a polyester film, a polyethylene terephthalate (PET) film, a polyimide film, a polyparabanic acid film, a polyether ether ketone film, a polyphenylene sulfide film, a polyamide film, a polycarbonate film, and a polyarylate film.

The film with resin 41 may include a cover film and the like if necessary. By including a cover film, it is possible to prevent entry of foreign matter and the like. The cover film is not particularly limited, and examples thereof include a polyolefin film, a polyester film, and a polymethylpentene film.

The support film and the cover film may be those subjected to surface treatments such as a matt treatment, a corona treatment, a release treatment, and a roughening treatment if necessary.

The method for manufacturing the film with resin 41 is not particularly limited as long as the film with resin 41 can be manufactured. Examples of the method for manufacturing the film with resin 41 include a method in which the varnish-like resin composition (resin varnish) is applied on the support film 43 and heated to manufacture the film with resin 41. The varnish-like resin composition is applied on the support film 43 using, for example, a bar coater. The applied resin composition is heated under the conditions of, for example, 40° C. or more and 180° C. or less and 0.1 minute or more and 10 minutes or less. The heated resin composition is formed as the uncured resin layer 42 on the support film 43. By the heating, the organic solvent can be decreased or removed by being volatilized from the resin varnish.

The resin composition according to the present embodiment is a resin composition, which affords a cured product having a high relative dielectric constant and a low dielectric loss tangent. For this reason, the film with resin including a resin layer containing this resin composition or a semi-cured product of this resin composition is a film with resin including a resin layer, which affords a cured product having a high relative dielectric constant and a low dielectric loss tangent. Moreover, this film with resin can be used when a wiring board including an insulating layer containing a cured product, which has a high relative dielectric constant and a low dielectric loss tangent, is suitably manufactured. A multilayer wiring board can be manufactured, for example, by laminating the film with resin on a wiring board and then peeling off the support film from the film with resin or by peeling off the support film from the film with resin and then laminating the film with resin on a wiring board. As a wiring board obtained using such a film with resin, there is obtained a wiring board including an insulating layer containing a cured product, which has a high relative dielectric constant and a low dielectric loss tangent. As a cured product obtained from the resin composition, there is obtained a cured product having not only a high relative dielectric constant and a low dielectric loss tangent but also a low coefficient of thermal expansion and excellent adhesive properties to a metal foil. For this reason, a wiring board obtained using a film with resin including a resin layer containing the resin composition or a semi-cured product of the resin composition includes an insulating layer having not only a high relative dielectric constant and a low dielectric loss tangent but also a low coefficient of thermal expansion and excellent adhesive properties to a metal foil.

According to the present invention, it is possible to provide a resin composition, which affords a cured product having a high relative dielectric constant and a low dielectric loss tangent. According to the present invention, it is possible to provide a prepreg, a film with resin, a metal foil with resin, a metal-clad laminate, and a wiring board, which are obtained using the resin composition.

Hereinafter, the present invention will be described more specifically with reference to examples, but the scope of the present invention is not limited thereto.

### EXAMPLES

### Examples 1 to 18 and Comparative Examples 1 to 4

The respective components used in a resin composition in the present Examples will be described.

### Polyphenylene Ether Compound (A): PPE

Modified PPE-1: Polyphenylene ether compound having vinylbenzyl group (ethenylbenzyl group) at terminal (OPE-2st 1200 manufactured by Mitsubishi Gas Chemical Company, Mn 1200, Mw 1600, a modified polyphenylene ether compound represented by Formula (10), where Ar is a phenylene group, R₁ to R₃ are a hydrogen atom, and p is 1)

Modified PPE-2: Polyphenylene ether compound having vinylbenzyl group (ethenylbenzyl group) at terminal (OPE-2st 2200 manufactured by Mitsubishi Gas Chemical Company, Mn 2200, Mw 3600, a modified polyphenylene ether compound represented by Formula (10), where Ar is a phenylene group, R₁ to R₃ are a hydrogen atom, and p is 1)

Modified PPE-3: Polyphenylene ether compound having vinylbenzyl group (ethenylbenzyl group) at terminal (a modified polyphenylene ether compound obtained by reacting polyphenylene ether with chloromethylstyrene).

Specifically, this is a modified polyphenylene ether compound obtained by conducting a reaction as follows.

First, 200 g of polyphenylene ether (SA90 manufactured by SABIC Innovative Plastics Co., Ltd., number of terminal hydroxyl groups: 2, weight average molecular weight Mw: 1700), 30 g of a mixture containing p-chloromethylstyrene and m-chloromethylstyrene at a mass ratio of 50:50 (chloromethylstyrene:CMS manufactured by Tokyo Chemical Industry Co., Ltd.), 1.227 g of tetra-n-butylammonium bromide as a phase transfer catalyst, and 400 g of toluene were introduced into a 1-liter three-necked flask equipped with a temperature controller, a stirrer, cooling equipment, and a dropping funnel and stirred. Then, the mixture was stirred until polyphenylene ether, chloromethylstyrene, and tetra-n-butylammonium bromide were dissolved in toluene. At that time, the mixture was gradually heated until the liquid temperature finally reached 75° C. Thereafter, an aqueous sodium hydroxide solution (20 g of sodium hydroxide/20 g of water) as an alkali metal hydroxide was added dropwise to the solution over 20 minutes. Thereafter, the mixture was further stirred at 75° C. for 4 hours. Next, the resultant in the flask was neutralized with hydrochloric acid at 10% by mass and then a large amount of methanol was added into the flask. By doing so, a precipitate was generated in the liquid in the flask. In other words, the product contained in the reaction solution in the flask was reprecipitated. Thereafter, this precipitate was taken out by filtration, washed three times with a mixed solution of methanol and water contained at a mass ratio of 80:20, and then dried under reduced pressure at 80° C. for 3 hours.

The obtained solid was analyzed by ¹H-NMR (400 MHZ, CDCl₃, TMS). As a result of NMR measurement, a peak attributed to a vinylbenzyl group (ethenylbenzyl group) was observed at 5 to 7 ppm. This made it possible to confirm that the obtained solid was a modified polyphenylene ether compound having a vinylbenzyl group (ethenylbenzyl group) as the substituent at the molecular terminal in the molecule. Specifically, it was confirmed that the obtained solid was ethenylbenzylated polyphenylene ether. This modified polyphenylene ether compound obtained was a modified polyphenylene ether compound represented by Formula (11), where Y was a dimethylmethylene group (a group represented by Formula (9), where R₃₃ and R₃₄ were a methyl group), Ar was a phenylene group, R₁ to R₃ were a hydrogen atom, and p was 1.

The number of terminal functional groups in the modified polyphenylene ether was measured as follows.

First, the modified polyphenylene ether was accurately weighed. The weight at that time is defined as X (mg). Thereafter, this modified polyphenylene ether weighed was dissolved in 25 mL of methylene chloride, 100 μL of an ethanol solution of tetraethylammonium hydroxide (TEAH) at 10% by mass (TEAH:ethanol (volume ratio)=15:85) was added to the solution, and then the absorbance (Abs) of this mixture at 318 nm was measured using a UV spectrophotometer (UV-1600 manufactured by Shimadzu Corporation). Then, the number of terminal hydroxyl groups in the modified polyphenylene ether was calculated from the measurement results using the following equation.

Residual OH amount (μmol/g)=[(25×Abs)/(ε×OPL×X)]×10⁶

Here, ε indicates the extinction coefficient and is 4700 L/mol·cm. OPL indicates the cell path length and is 1 cm.

Since the calculated residual OH amount (the number of terminal hydroxyl groups) in the modified polyphenylene ether is almost zero, it was found that the hydroxyl groups in the polyphenylene ether before being modified are almost modified. From this fact, it was found that the number of terminal hydroxyl groups decreased from the number of terminal hydroxyl groups in polyphenylene ether before being modified is the number of terminal hydroxyl groups in polyphenylene ether before being modified. In other words, it was found that the number of terminal hydroxyl groups in polyphenylene ether before being modified is the number of terminal functional groups in the modified polyphenylene ether. In other words, the number of terminal functional groups was two.

In addition, the intrinsic viscosity (IV) of the modified polyphenylene ether was measured in methylene chloride at 25° C. Specifically, the intrinsic viscosity (IV) of the modified polyphenylene ether was measured in a methylene chloride solution (liquid temperature: 25° C.) of the modified polyphenylene ether at 0.18 g/45 ml using a viscometer (AVS500 Visco System manufactured by SCHOTT Instruments GmbH). As a result, the intrinsic viscosity (IV) of the modified polyphenylene ether was 0.086 dl/g.

The molecular weight distribution of the modified polyphenylene ether was measured by GPC. Moreover, the weight average molecular weight (Mw) was calculated from the obtained molecular weight distribution. As a result, Mw was 1900.

Modified PPE-4: Modified polyphenylene ether obtained by modifying terminal hydroxyl group of polyphenylene ether with methacryloyl group (a modified polyphenylene ether compound represented by Formula (12), where Y is a dimethylmethylene group (a group represented by Formula (9), where R₃₃ and R₃₄ are a methyl group), SA9000 manufactured by SABIC Innovative Plastics Co., Ltd., weight average molecular weight Mw: 1700, number of terminal functional groups: 2)

### Maleimide Compound (B)

Maleimide compound-1: Bisphenol A diphenyl ether bismaleimide (BMI-4000 manufactured by Daiwa Kasei Industry Co., Ltd., functional group equivalent of maleimide group: 285 g/eq., molecular weight: 570)

Maleimide compound-2: Polyphenylmethane maleimide (BMI-2300 manufactured by Daiwa Kasei Industry Co., Ltd., functional group equivalent of maleimide group: 180 g/eq., molecular weight: 538)

Maleimide compound-3: Maleimide compound represented by Formula (17) (BMI-689 manufactured by Designer Molecules Inc., functional group equivalent of maleimide group: 344.5 g/eq., molecular weight: 689)

Maleimide compound-4: Maleimide compound having phenylmaleimide group and indane structure in molecule (a maleimide compound represented by Formula (14), where Ra represents a methyl group, q represents 2, and r represents 0, functional group equivalent of maleimide group: 428 g/eq., molecular weight: 856)

### Ceramic Particles (C)

### (Aluminum Titanate Particles (C1))

Aluminum titanate particles-1: Aluminum titanate particles produced by precipitation method (ATB manufactured by KAWAI LIME INDUSTRY Co., Ltd., specific gravity: 3.7 g/cm³, average particle size (D50): 2 μm)

Aluminum titanate particles-2: Aluminum titanate particles produced by precipitation method (ATI manufactured by KAWAI LIME INDUSTRY Co., Ltd., specific gravity: 3.7 g/cm³, average particle size (D50): 2 μm)

Aluminum titanate particles-3: Aluminum titanate particles produced by solid phase method (TM-19 manufactured by MARUSU GLAZE Co., Ltd., specific gravity: 3.4 g/cm³, average particle size (D50): 7 μm)

(Ceramic Particles (C2) Other than Aluminum Titanate Particles (C1): Other Ceramic Particles)

Strontium titanate particles: ST-A manufactured by Fuji Titanium Industry Co., Ltd. (specific gravity: 5.1 g/cm³, average particle size (D50): 1.6 μm)

Calcium titanate particles: CT manufactured by Fuji Titanium Industry Co., Ltd. (specific gravity: 4 g/cm³, average particle size (D50): 2.1 μm)

Titanium dioxide particles: TM-1 manufactured by Fuji Titanium Industry Co., Ltd. (specific gravity: 4.1 g/cm³, average particle size (D50): 0.8 μm)

Silica particles: SC2500-SXJ manufactured by ADMATECHS COMPANY LIMITED (specific gravity: 2.2 g/cm³, average particle size (D50): 0.5 μm)

Aluminum oxide particles: AO-502 manufactured by ADMATECHS COMPANY LIMITED (specific gravity: 3.8 g/cm³, average particle size (D50): 0.3 μm)

### (Reaction Initiator)

PBP: Peroxide (α,α′-di(t-butylperoxy)diisopropylbenzene, Perbutyl P (PBP) manufactured by NOF CORPORATION)

### Preparation Method

First, the respective components other than the ceramic particles (C) were added to and mixed in toluene at the compositions (parts by mass) presented in Tables 1 to 3 so that the solid concentration was 50% by mass. The mixture was stirred for 60 minutes. After that, the ceramic particles (C) were added to the obtained liquid, and the ceramic particles (C) were dispersed using a bead mill. By doing so, a varnish-like resin composition (varnish) was obtained.

Next, a prepreg and an evaluation substrate 1 (metal-clad laminate) were obtained as follows.

The obtained varnish was impregnated into a fibrous base material (glass cloth: #1067 type, E glass manufactured by Asahi Kasei Corporation) and then heated and dried at 120° C. to 150° C. for 3 minutes, thereby fabricating a prepreg. At that time, the content (resin content) of the components constituting the resin composition with respect to the prepreg was adjusted to be 73% to 80% by mass by the curing reaction.

Next, an evaluation substrate 1 (metal-clad laminate) was obtained as follows.

Twelve sheets of each of the obtained prepregs were stacked, and copper foil (GTHMP12 manufactured by Furukawa Electric Co., Ltd., thickness: 12 μm) was disposed on both sides of the stacked body. This as a body to be pressed was heated to a temperature of 220° C. at a rate of temperature rise of 3° C./min and heated and pressed under the conditions of 220° C., 90 minutes, and a pressure of 3 MPa, thereby obtaining an evaluation substrate 1 (metal-clad laminate) having a copper foil bonded to both surfaces and a thickness of about 0.8 mm.

The evaluation substrate 1 (metal-clad laminate) fabricated as described above was evaluated by the following methods.

### Dielectric Properties (Relative Dielectric Constant and Dielectric Loss Tangent)

The relative dielectric constant and dielectric loss tangent at 10 GHz were measured by the cavity perturbation method using an unclad substrate obtained by removing the copper foil from the evaluation substrate 1 (metal-clad laminate) by etching as a test piece. Specifically, the relative dielectric constant and dielectric loss tangent of the evaluation substrate at 10 GHz were measured using a network analyzer (N5230A manufactured by Keysight Technologies). When the relative dielectric constant acquired by the measurement was 4 or more, it was determined as “acceptable”. When the dielectric loss tangent acquired by the measurement was 0.0055 or less, it was determined as “acceptable”.

### Copper Foil Peel Strength

The copper foil was peeled off from the evaluation substrate 1 (metal-clad laminate), and the peel strength at that time was measured in conformity with JIS C 6481 (1996). Specifically, a pattern having a width of 10 mm and a length of 100 mm was formed on the evaluation substrate, the copper foil was peeled off at a speed of 50 mm/min using a tensile tester, and the peel strength (N/mm) at that time was measured. When the copper foil peel strength acquired by the measurement was 0.45 N/mm or more, it was determined as “acceptable”.

Next, separately from the evaluation substrate 1, a prepreg and an evaluation substrate 2 (metal-clad laminate) were obtained as follows.

The obtained varnish was impregnated into a fibrous base material (glass cloth: #2116 type, E glass manufactured by Asahi Kasei Corporation) and then heated and dried at 120° C. to 150° C. for 3 minutes, thereby fabricating a prepreg. At that time, the content (resin content) of the components constituting the resin composition with respect to the prepreg was adjusted to be 48% to 53% by mass by the curing reaction.

Next, an evaluation substrate (metal-clad laminate) was obtained as follows.

Copper foil (GTHMP12 manufactured by Furukawa Electric Co., Ltd., thickness: 12 μm) was disposed on both sides of one sheet of each of the obtained prepregs. This as a body to be pressed was heated to a temperature of 220° C. at a rate of temperature rise of 3° C./min and heated and pressed under the conditions of 220° C., 90 minutes, and a pressure of 3 MPa, thereby obtaining an evaluation substrate 2 (metal-clad laminate) having a copper foil bonded to both surfaces and a thickness of about 0.1 mm.

The evaluation substrate 2 (metal-clad laminate) fabricated as described above was evaluated by the following methods.

### Coefficient of Thermal Expansion

Using an unclad substrate obtained by removing the copper foil from the evaluation substrate 2 (metal-clad laminate) by etching as a test piece, the coefficient of thermal expansion (CTE: ppm/° C.) in the Y-axis direction was measured by TMA (thermo-mechanical analysis) in conformity with JIS C 6481. For the measurement, a TMA instrument (TMA6000 manufactured by SII Nano Technology Inc.) was used, and the measurement was performed in a range of 30° C. to 260° C. When the coefficient of thermal expansion acquired by the measurement was 14 ppm/° C. or less, it was determined as “acceptable”.

The results of each of the evaluations are presented in Tables 1 to 3.

TABLE 1

| | | | | Example | | | | Comparative Example | | | |
|---|---|---|---|---|---|---|---|---|---|---|---|
| | | | | 1 | 2 | 3 | 4 | 1 | 2 | 3 | 4 |
| Composition | PPE | Modified PPE-1 | | 100 | — | 57 | 57 | 57 | 57 | 57 | 57 |
| (parts by | Maleimide | Maleimide compound-1 | | — | 100 | 43 | 43 | 43 | 43 | 43 | 43 |
| mass) | compound | | | | | | | | | | |
| | Ceramic | Aluminum | Aluminum | 110 | 110 | 110 | 110 | — | — | — | — |
| | particles | titanate | titanate | | | | | | | | |
| | | particles | particles-1 | | | | | | | | |
| | | Other | Strontium | — | — | — | — | — | 110 | — | — |
| | | ceramic | titanate | | | | | | | | |
| | | particles | particles | | | | | | | | |
| | | | Calcium | — | — | — | — | — | — | 110 | — |
| | | | titanate | | | | | | | | |
| | | | particles | | | | | | | | |
| | | | Titanium | — | — | — | — | — | — | — | 110 |
| | | | dioxide | | | | | | | | |
| | | | particles | | | | | | | | |
| | | | Silica | — | — | — | — | 110 | — | — | — |
| | | | particles | | | | | | | | |
| | Reaction | PBP | | — | 1 | — | 1 | — | — | — | — |
| | initiator | | | | | | | | | | |

| | | | | | | | | | | |
|---|---|---|---|---|---|---|---|---|---|---|
| Evaluation | Dielectric | Relative dielectric | 4.4 | 4.4 | 4.3 | 4.3 | 3.4 | 5.1 | 5.3 | 5.0 |
| | properties | constant | | | | | | | | |
| | | Dielectric loss tangent | 0.0040 | 0.0055 | 0.0048 | 0.0049 | 0.0055 | 0.0057 | 0.0057 | 0.0060 |

| | | | | | | | | |
|---|---|---|---|---|---|---|---|---|
| Coefficient of thermal expansion | 14 | 13 | 13 | 12 | 13 | 14 | 14 | 15 |
| (ppm/° C.) | | | | | | | | |
| Copper foil peel strength (N/mm) | 0.55 | 0.45 | 0.50 | 0.50 | 0.50 | 0.45 | 0.40 | 0.40 |

TABLE 2

| | | | | Example | | | | |
|---|---|---|---|---|---|---|---|---|
| | | | | 3 | 5 | 6 | 7 | 8 |
| Composition | PPE | Modified PPE-1 | | 57 | 57 | 57 | — | — |
| (parts by | | Modified PPE-2 | | — | — | — | 57 | — |
| mass) | | Modified PPE-3 | | — | — | — | — | 57 |
| | | Modified PPE-4 | | — | — | — | — | — |
| | Maleimide | Maleimide compound-1 | | 43 | 43 | 43 | 43 | 43 |
| | compound | Maleimide compound-2 | | — | — | — | — | — |
| | | Maleimide compound-3 | | — | — | — | — | — |
| | | Maleimide compound-4 | | — | — | — | — | — |
| | Ceramic | Aluminum | Aluminum titanate particles-1 | 110 | — | — | 110 | 110 |
| | particles | titanate particles | Aluminum titanate particles-2 | — | 110 | — | — | — |
| | | | Aluminum titanate particles-3 | — | — | 110 | — | — |
| | Reaction | PBP | | — | — | — | — | — |
| | initiator | | | | | | | |
| Evaluation | Dielectric | Relative dielectric constant | | 4.3 | 4.3 | 4.3 | 4.3 | 4.3 |
| | properties | Dielectric loss tangent | | 0.0048 | 0.0047 | 0.0053 | 0.0049 | 0.0049 |
| | Coefficient of thermal expansion (ppm/° C.) | | | 13 | 12 | 13 | 13 | 13 |
| | Copper foil peel strength (N/mm) | | | 0.50 | 0.50 | 0.45 | 0.50 | 0.50 |
| | | | | Example | | | | |
| | | | | 9 | 10 | 11 | 12 | 13 |
| Composition | PPE | Modified PPE-1 | | — | 57 | 57 | 57 | 40 |
| (parts by | | Modified PPE-2 | | — | — | — | — | — |
| mass) | | Modified PPE-3 | | — | — | — | — | — |
| | | Modified PPE-4 | | 57 | — | — | — | — |
| | Maleimide | Maleimide compound-1 | | 43 | — | — | — | 30 |
| | compound | Maleimide compound-2 | | — | 43 | — | — | — |
| | | Maleimide compound-3 | | — | — | 43 | — | 15 |
| | | Maleimide compound-4 | | — | — | — | 43 | 15 |
| | Ceramic | Aluminum | Aluminum titanate particles-1 | 110 | 110 | 110 | 110 | 110 |
| | particles | titanate particles | Aluminum titanate particles-2 | — | — | — | — | — |
| | | | Aluminum titanate particles-3 | — | — | — | — | — |
| | Reaction | PBP | | 1 | — | — | — | — |
| | initiator | | | | | | | |

| | | | | | | | |
|---|---|---|---|---|---|---|---|
| Evaluation | Dielectric | Relative dielectric constant | 4.3 | 4.3 | 4.0 | 4.1 | 4.2 |
| | properties | Dielectric loss tangent | 0.0049 | 0.0048 | 0.0032 | 0.0032 | 0.0035 |

| | | | | | |
|---|---|---|---|---|---|
| Coefficient of thermal expansion (ppm/° C.) | 14 | 13 | 14 | 13 | 13 |
| Copper foil peel strength (N/mm) | 0.50 | 0.50 | 0.75 | 0.75 | 0.70 |

TABLE 3

| | | | | Example | | | | | |
|---|---|---|---|---|---|---|---|---|---|
| | | | | 3 | 14 | 15 | 16 | 17 | 18 |
| Composition | PPE | Modified PPE-1 | | 57 | 57 | 57 | 57 | 57 | 57 |
| (parts by | Maleimide | Maleimide compound-1 | | 43 | 43 | 43 | 43 | 43 | 43 |
| mass) | compound | | | | | | | | |
| | Ceramic | Aluminum | Aluminum titanate particles-1 | 110 | 200 | 110 | 110 | 110 | 110 |
| | particles | titanate particles | | | | | | | |
| | | Other ceramic | Strontium titanate particles | — | — | 100 | — | — | — |
| | | particles | Calcium titanate particles | — | — | — | 80 | — | — |
| | | | Titanium dioxide particles | — | — | — | — | 80 | — |
| | | | Aluminum oxide particles | — | — | — | — | — | 75 |

| | | | | | | | | |
|---|---|---|---|---|---|---|---|---|
| Evaluation | Dielectric | Relative dielectric constant | 4.3 | 4.7 | 6.9 | 6.7 | 5.7 | 4.2 |
| | properties | Dielectric loss tangent | 0.0048 | 0.0045 | 0.0055 | 0.0053 | 0.0055 | 0.0054 |

| | | | | | | |
|---|---|---|---|---|---|---|
| Coefficient of thermal expansion (ppm/° C.) | 13 | 10 | 12 | 12 | 13 | 13 |
| Copper foil peel strength (N/mm) | 0.50 | 0.45 | 0.45 | 0.45 | 0.45 | 0.45 |

Tables 1 to 3 present the compositions of resin compositions containing both the polyphenylene ether compound (A) and the maleimide compound (B), the polyphenylene ether compound (A), or the maleimide compound (B) and evaluation results. As can be seen from Tables 1 to 3, when metal-clad laminates arc fabricated using the resin compositions, in cases where the resin composition contains the ceramic particles (C) including the aluminum titanate particles (C1) (Examples 1 to 18), the relative dielectric constant is 4 or more and the dielectric loss tangent is 0.0055 or less unlike those in cases where the aluminum titanate particles (CI) are not contained but the ceramic particles (C2) other than the aluminum titanate particles (C1) are contained (Comparative Examples 1 to 4). From this fact, it can be seen that when the resin compositions according to Examples 1 to 18 are used, cured products having a high relative dielectric constant and a low dielectric loss tangent are obtained, and metal-clad laminates including insulating layers containing such cured products are obtained. When metal-clad laminates are fabricated using the resin compositions of Examples 1 to 18, the coefficient of thermal expansion is 14 ppm/° C. or less and the copper foil peel strength is 0.45 N/mm or more. From this fact, it can be seen that there arc obtained metal-clad laminates having not only a high relative dielectric constant and a low dielectric loss tangent but also a low coefficient of thermal expansion and a high copper foil peel strength.

In both cases where the content of the ceramic particles (C) including the aluminum titanate particles (C1) is 110 parts by mass (for example, Example 3) and 200 parts by mass (Example 14) with respect to 100 parts by mass of the total mass of the polyphenylene ether compound (A) and the maleimide compound (B), it can be seen that there is obtained a metal-clad laminate including an insulating layer containing a cured product, which has a high relative dielectric constant and a low dielectric loss tangent. Example 3, in which the content of the ceramic particles (C) including the aluminum titanate particles (C1) is 110 parts by mass, has a higher dielectric loss tangent than Example 14. Example 14, in which the content of the ceramic particles (C) including the aluminum titanate particles (C1) is 200 parts by mass, has a higher relative dielectric constant than Example 3. From these facts, it is preferable that the content of the ceramic particles (C) including the aluminum titanate particles (C1) is neither too low nor too high, and for example, the content is preferably 100 to 250 parts by mass with respect to 100 parts by mass of the total mass of the polyphenylene ether compound (A) and the maleimide compound (B).

In a case where the ceramic particles (C) include not only the aluminum titanate particles (C1) but also ceramic particles (C2) other than the aluminum titanate particles (C1) (Examples 15 to 18), it can be seen that there is obtained a metal-clad laminate including an insulating layer containing a cured product, which has a high relative dielectric constant and a low dielectric loss tangent. In other words, when the content of the ceramic particles (C) is in the above range in a case where the aluminum titanate particles (C1) and the ceramic particles (C2) are used concurrently (Examples 15 to 18) as well, it can be seen that there is obtained a metal-clad laminate including an insulating layer containing a cured product, which has a high relative dielectric constant and a low dielectric loss tangent.

This application is based on Japanese Patent Application No. 2021-050474 filed on Mar. 24, 2021, the contents of which are included in the present application.

In order to express the present invention, the present invention has been described above appropriately and sufficiently through the embodiments. However, it should be recognized by those skilled in the art that changes and/or improvements of the above-described embodiments can be readily made. Accordingly, changes or improvements made by those skilled in the art shall be construed as being included in the scope of the claims unless otherwise the changes or improvements are at the level which departs from the scope of the appended claims.

### INDUSTRIAL APPLICABILITY

According to the present invention, there is provided a resin composition, which affords a cured product having a high relative dielectric constant and a low dielectric loss tangent. In addition, according to the present invention, a prepreg, a film with resin, a metal foil with resin, a metal-clad laminate, and a wiring board which are obtained using the resin composition are provided.

1. A resin composition comprising:
at least one of a polyphenylene ether compound (A), having at least one of a group represented by the following Formula (1) and a group represented by the following Formula (2) in a molecule, and a maleimide compound (B); and
ceramic particles (C) including aluminum titanate particles (C1), 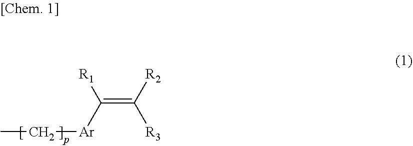
[in Formula (1), p represents 0 to 10, Ar represents an arylene group, and R₁ to R₃ each independently represent a hydrogen atom or an alkyl group], 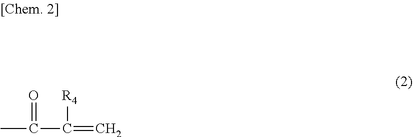
[in Formula (2), R₄ represents a hydrogen atom or an alkyl group].

2. The resin composition according to claim 1, wherein a content of the ceramic particles (C) is 100 to 250 parts by mass with respect to 100 parts by mass of a sum of the polyphenylene ether compound (A) and the maleimide compound (B).

3. The resin composition according to claim 1, wherein the ceramic particles (C) further include at least one selected from the group consisting of strontium titanate particles, calcium titanate particles, barium titanate particles, magnesium titanate particles, zinc titanate particles, lanthanum titanate particles, neodymium titanate particles, titanium dioxide particles, aluminum oxide particles, and silica particles.

4. The resin composition according to claim 1, wherein the maleimide compound (B) includes at least one of a maleimide compound (B1) having a phenylmaleimide group in a molecule and a maleimide compound (B2) having an aliphatic hydrocarbon group having 11 or more carbon atoms in a molecule.

5. A prepreg comprising:
the resin composition according to claim 1 or a semi-cured product of the resin composition; and
a fibrous base material.

6. The prepreg according to claim 5, wherein a relative dielectric constant of a cured product of the prepreg is 4 or more at a frequency of 10 GHz, and a dielectric loss tangent of a cured product of the prepreg is 0.0055 or less at a frequency of 10 GHz.

7. A film with resin comprising:
a resin layer containing the resin composition according to claim 1 or a semi-cured product of the resin composition; and
a support film.

8. A metal foil with resin comprising:
a resin layer containing the resin composition according to claim 1 or a semi-cured product of the resin composition; and
a metal foil.

9. A metal-clad laminate comprising:
an insulating layer containing a cured product of the resin composition according to claim 1; and
a metal foil.

10. The metal-clad laminate according to claim 9, wherein a relative dielectric constant of the insulating layer is 4 or more at a frequency of 10 GHZ, and a dielectric loss tangent of the insulating layer is 0.0055 or less at a frequency of 10 GHz.

11. A wiring board comprising:
an insulating layer containing a cured product of the resin composition according to claim 1; and
wiring.

12. The wiring board according to claim 11, wherein a relative dielectric constant of the insulating layer is 4 or more at a frequency of 10 GHz, and a dielectric loss tangent of the insulating layer is 0.0055 or less at a frequency of 10 GHz.

13. A metal-clad laminate comprising:
an insulating layer containing a cured product of the prepreg according to claim 5; and
a metal foil.

14. The metal-clad laminate according to claim 13, wherein a relative dielectric constant of the insulating layer is 4 or more at a frequency of 10 GHz, and a dielectric loss tangent of the insulating layer is 0.0055 or less at a frequency of 10 GHz.

15. A wiring board comprising:
an insulating layer containing a cured product of the prepreg according to claim 5; and
wiring.

16. The wiring board according to claim 15, wherein a relative dielectric constant of the insulating layer is 4 or more at a frequency of 10 GHz, and a dielectric loss tangent of the insulating layer is 0.0055 or less at a frequency of 10 GHz.
